(19) United States
(12) Patent Application Publication
(10) Pub. No.: US 2014/0331314 A1
(43) Pub. Date: Nov. 6, 2014

(54) Time and Sleep Control System and Method

(71) Applicant: Fuhu Holdings, Inc., El Segundo, CA (US)

(72) Inventor: Robb Fujioka, Manhattan Beach, CA (US)

(21) Appl. No.: 14/335,844

(22) Filed: Jul. 18, 2014

Related U.S. Application Data
(63) Continuation-in-part of application No. 13/852,840, filed on Mar. 28, 2013.
(60) Provisional application No. 61/894,412, filed on Oct. 22, 2013.

(51) Int. Cl. G06F 21/62

(52) U.S. Cl. CPC G06F 21/6218
USPC 726/17

(57) ABSTRACT

A time and sleep control system and method is disclosed. According to one embodiment, a computer-implemented method includes providing a first user interface on a computing device that provides digital content to a first user, providing a second user interface associated with an operating environment on the computing device to a second user, where the second user interface provides unrestricted access to the digital content, receiving a request that is configured to be provided by the second user to access the first user interface from the operating environment, where the request allows the second user to provide restricted access to the digital content on the first user interface, granting the request, and receiving a desired time duration on the computing device that is configured to be provided by the second user, where the desired time duration controls a length of time that the first user is allowed to access the first user interface.

### CROSS-REFERENCE TO RELATED APPLICATIONS

The present application claims priority to U.S. Provisional Patent Application No. 61/847,921 filed on Jul. 18, 2013, entitled “Time and Sleep Control System and Method” and U.S. Provisional Patent Application No. 61/896,412 filed on Oct. 28, 2013, entitled “Time and Sleep Control System and Method”, which are herein incorporated by reference.

The present application is a continuation-in-part of U.S. patent application Ser. No. 13/852,840 filed on Mar. 28, 2013, entitled “Tablet Computer” which is a continuation of U.S. patent application Ser. No. 13/841,461 filed on Mar. 15, 2013, entitled “Tablet Computer”, which are herein incorporated by reference.

The present application is a continuation-in-part of U.S. patent application Ser. No. 12/381,663 filed on Mar. 13, 2009, entitled “Widgetized Avatar and a Method and System of Creating and Using Same”, which claims the benefit of U.S. Provisional Patent Application No. 61/069,336 filed on Mar. 13, 2008, entitled “Widgetized Avatar and a Method and System of Creating and Using Same”, which are herein incorporated by reference.

The present application is a continuation-in-part of U.S. patent application Ser. No. 12/381,666 filed on Mar. 12, 2009, entitled “Hypervisor and Virtual Machine Ware”, which claims the benefit of U.S. Provisional Patent Application No. 61/070,942 filed on Mar. 26, 2008, entitled “Hypervisor and Virtual Machine Ware”, which are herein incorporated by reference.

The present application is a continuation-in-part of U.S. patent application Ser. No. 12/381,905 filed on Mar. 17, 2009, entitled “Social Based Search Engine, System and Method”, which claims the benefit of U.S. Provisional Patent Application No. 61/069,775 filed on Mar. 17, 2008, entitled “Social Based Search Engine, System And Method”, which are herein incorporated by reference.

The present application is a continuation-in-part of U.S. patent application Ser. No. 12/383,001 filed on Mar. 17, 2009, entitled “Widget Platform, System and Method”, which claims the benefit of U.S. Provisional Patent Application No. 61/069,777 filed on Mar. 17, 2008, entitled “Widget Platform, System and Method”, which are herein incorporated by reference.

The present application is a continuation-in-part of U.S. patent application Ser. No. 12/383,456 filed on Mar. 24, 2009, entitled “Webtop and Monetization Engine, System and Method”, which claims the benefit of U.S. Provisional Patent Application No. 61/070,611 filed on Mar. 24, 2008, entitled “Webtop and Monetization Engine, System and Method”, which are herein incorporated by reference.

The present application is a continuation-in-part of U.S. patent application Ser. No. 12/459,171 filed on Jun. 26, 2009, entitled “System and Method for Providing Applications and Peripherals to a Fixed Price Component-based Computing Platform”, which claims the benefit of U.S. Provisional Patent Application No. 61/090,054 filed on Aug. 19, 2008, entitled “Modular Application Computing Apparatus, System and Method” and U.S. Provisional Patent Application No. 61/106,645 filed on Oct. 20, 2008, entitled “System and Method for Providing Applications and Peripherals to a Fixed Price Component-based Computing Platform”, which are herein incorporated by reference.

The present application is a continuation-in-part of U.S. patent application Ser. No. 12/494,940 filed on Jun. 30, 2009, entitled “Widgetized Avatar And A Method And System Of Creating And Using Same”, which claims the benefit of U.S. Provisional Patent Application No. 61/190,810 filed Sep. 2, 2008, entitled “Widgetized Avatar and a Method and System of Creating and Using Same”, and also claims priority to U.S. patent application Ser. No. 12/381,663 filed on Mar. 13, 2009, entitled “Widgetized Avatar and a Method and System of Creating and Using Same”, which claims the benefit of U.S. Provisional Patent Application No. 61/069,336 filed on Mar. 13, 2008, entitled “Widgetized Avatar and a Method and System of Creating and Using Same”, which are herein incorporated by reference.

The present application is a continuation-in-part of U.S. patent application Ser. No. 12/544,129 filed on Aug. 19, 2009, entitled “Modular Application Computing Apparatus, System and Method”, which claims the benefit of U.S. Provisional Patent Application No. 61/090,054 filed on Aug. 19, 2008, entitled “Modular Application Computing Apparatus, System and Method”, which are herein incorporated by reference.

The present application is a continuation-in-part of U.S. patent application Ser. No. 12/584,264 filed on Sep. 2, 2009, entitled “Widgetized Avatar and a Method and System of Creating and Using Same”, which claims the benefit of U.S. Provisional Patent Application No. 61/190,810 filed on Sep. 2, 2008, entitled “A Widgetized Avatar and a Method and System of Creating and Using Same”, which are herein incorporated by reference.

The present application is a continuation-in-part of U.S. patent application Ser. No. 12/584,265 filed on Sep. 2, 2009, entitled “Stable Active X Linux Based Operating Environment”, which claims the benefit of U.S. Provisional Patent Application No. 61/190,809 filed on Sep. 2, 2008, entitled “Stable Active X Linux Based Operating Environment”, which are herein incorporated by reference.

The present application is a continuation-in-part of U.S. patent application Ser. No. 12/584,275 filed on Sep. 2, 2009, entitled “Modular Application Computing Apparatus, System and Method”, which claims the benefit of U.S. Provisional Patent Application No. 61/190,806 filed on Sep. 2, 2008, entitled “Modular Application Computing Apparatus, System and Method”, which are herein incorporated by reference.

The present application is a continuation-in-part of U.S. patent application Ser. No. 12/586,777 filed on Sep. 28, 2009, entitled “Hypervisor and Webtop in a Set Top Box Environment”, which claims the benefit of U.S. Provisional Patent Application No. 61/100,416 filed on Sep. 26, 2008, entitled “Hypervisor and Webtop in a Set Top Box Environment”, which are herein incorporated by reference.

The present application is a continuation-in-part of U.S. patent application Ser. No. 12/586,884 filed on Sep. 29, 2009, entitled “Device and Method for Creating, Distributing, Managing and Monetizing Widgets”, which claims the benefit of U.S. Provisional Patent Application No. 61/210,190 filed on Mar. 12, 2009, entitled “A Device and Method for Creating, Distributing, Managing and Monetizing Widgets”, which are herein incorporated by reference.

The present application is a continuation-in-part of U.S. patent application Ser. No. 12/586,904 filed on Sep. 29, 2009, entitled “Device and Method for Creating, Distributing, Managing and Monetizing Widgets”, which is a continuation of U.S. patent application Ser. No. 12/586,884 filed on Sep. 29, 2009, entitled “Device and Method for Creating, Distributing, Managing and Monetizing Widgets”, which claims the benefit of U.S. Provisional Patent Application No. 61/210,190 filed on Mar. 12, 2009, entitled “A Device and Method for Creating, Distributing, Managing and Monetizing Widgets”, which are herein incorporated by reference.

The present application is a continuation-in-part of U.S. patent application Ser. No. 12/592,207 filed on Nov. 20, 2009, entitled “Widgetized Avatar and a Method and System of Creating and Using Same”, which is a continuation of U.S. patent application Ser. No. 12/381,663 filed on Mar. 13, 2009, entitled “A Widgetized Avatar and a Method and System of Creating and Using Same”, which are herein incorporated by reference.

The present application is a continuation-in-part of U.S. patent application Ser. No. 12/592,508 filed on Nov. 25, 2009, entitled “Webtop and Monetization Engine, System and Method”, which is a continuation-in-part of U.S. patent application Ser. No. 12/383,456 filed on Mar. 24, 2009, entitled “Webtop and Monetization Engine, System and Method”, which are herein incorporated by reference.

The present application is a continuation-in-part of U.S. patent application Ser. No. 12/628,046 filed on Nov. 30, 2009, entitled “Virtual Marketplace Accessible to Widgetized Avatars”, which claims the benefit of U.S. Provisional Patent Application No. 61/207,980 filed on Feb. 17, 2009, entitled “System And Method For Providing Expert Search In A Modular Computing System”, and is a continuation-in-part of U.S. patent application Ser. No. 12/592,207 filed Nov. 20, 2009, entitled “A Widgetized Avatar And A Method And System Of Creating And Using Same”, which is a continuation of U.S. patent application Ser. No. 12/381,663 filed on Mar. 13, 2009, entitled “A Widgetized Avatar And A Method And System Of Creating And Using Same”, which are herein incorporated by reference.

The present application is a continuation-in-part of U.S. patent application Ser. No. 12/628,075 filed on Nov. 30, 2009, entitled “Widgetized Avatar and A Method and System of Virtual Commerce Including Same”, which is a continuation of U.S. patent application Ser. No. 12/592,207 filed on Nov. 20, 2009, entitled “Widgetized Avatar and a Method and System of Creating and Using Same”, which is a continuation of U.S. patent application Ser. No. 12/494,940 filed on Jun. 30, 2009, entitled “Widgetized Avatar And A Method And System Of Creating And Using Same”, which claims the benefit of U.S. Provisional Patent Application No. 61/190,810 filed on Sep. 2, 2008, entitled “Widgetized Avatar And A Method And System Of Creating And Using Same”; U.S. patent application Ser. No. 12/592,207, and Ser. No. 12/494,940 are continuations of U.S. patent application Ser. No. 12/381,663 filed on Mar. 13, 2009, entitled “Widgetized Avatar And A Method And System Of Creating And Using Same”, which claims the benefit of U.S. Provisional Patent Application No. 61/069,336 filed on Mar. 13, 2008, entitled “Widgetized Avatar And A Method And System Of Creating And Using Same”, which are herein incorporated by reference.

The present application is a continuation-in-part of U.S. patent application Ser. No. 12/628,031 filed on Nov. 30, 2009, entitled “Widgetized Avatar and a Method and System of Creating and Using Same Including Storefronts”, which claims the benefit of U.S. Provisional Patent Application No. 61/207,980 filed on Feb. 17, 2009, entitled “System And Method For Providing Expert Search In A Modular Computing System”, and is a continuation-in-part of U.S. patent application Ser. No. 12/592,207 filed on Nov. 20, 2009, entitled “A Widgetized Avatar And A Method And System Of Creating And Using Same”, which is a continuation of U.S. patent application Ser. No. 12/381,663 filed on Mar. 13, 2009, entitled “A Widgetized Avatar And A Method And System Of Creating And Using Same”, which are herein incorporated by reference.

The present application is a continuation-in-part of U.S. patent application Ser. No. 12/628,090 filed on Nov. 30, 2009, entitled “Widgetized Avatar and a Method and System of Creating and Using Same”, which is a continuation-in-part of U.S. patent application Ser. No. 12/592,207 filed on Nov. 20, 2009, entitled “A Widgetized Avatar And A Method And System Of Creating And Using Same”, which is a continuation of U.S. patent application Ser. No. 12/381,663 filed on Mar. 13, 2009, entitled “A Widgetized Avatar And A Method And System Of Creating And Using Same”, which are herein incorporated by reference.

The present application is a continuation-in-part of U.S. patent application Ser. No. 12/655,308 filed on Dec. 29, 2009, entitled “System and Method for Purchasing Applications and Peripherals”, which claims the benefit of U.S. Provisional Patent Application No. 61/204,141 filed on Dec. 31, 2008, entitled “System and Method for Purchasing Applications and Peripherals”, which are herein incorporated by reference.

The present application is a continuation-in-part of U.S. patent application Ser. No. 12/701,000 filed on Feb. 5, 2010, entitled “Virtual Marketplace Accessible To Widgetized Avatars”, which is a continuation-in-part of U.S. patent application Ser. No. 12/628,046 filed on Nov. 30, 2009, entitled “A Virtual Marketplace Accessible To Widgetized Avatars”, which claims the benefit of U.S. Provisional Patent Application No. 61/207,980 filed on Feb. 17, 2009, entitled “System And Method For Providing Expert Search In A Modular Computing System”, and is a continuation-in-part of U.S. patent application Ser. No. 12/592,207 filed on Nov. 20, 2009, entitled “A Widgetized Avatar And A Method And System Of Creating And Using Same”, which is a continuation of U.S. patent application Ser. No. 12/381,663 filed on Mar. 13, 2009, entitled “A Widgetized Avatar And A Method And System Of Creating And Using Same”, which are herein incorporated by reference.

The present application is a continuation-in-part of U.S. patent application Ser. No. 12/707,203 filed on Feb. 17, 2010, entitled “System and Method For Providing Expert Search In A Modular Computing System”, which claims the benefit of U.S. Provisional Patent Application No. 61/207,980 filed on Feb. 17, 2009, entitled “System and Method for Providing Expert Search In a Modular Computing System”, which are herein incorporated by reference.

The present application is a continuation-in-part of U.S. patent application Ser. No. 12/709,710 filed on Feb. 22, 2010, entitled “Virtual Marketplace Accessible To Widgetized Avatars”, which is a continuation of U.S. patent application Ser. No. 12/701,000 filed on Feb. 5, 2010, entitled “Virtual Marketplace Accessible To Widgetized Avatars”, which is a continuation-in-part of U.S. patent application Ser. No. 12/628,046 filed on Nov. 30, 2009, entitled “A Virtual Marketplace Accessible To Widgetized Avatars”, which claims the benefit of U.S. Provisional Patent Application No. 61/207,980 filed on Feb. 17, 2009, entitled “System And Method For Providing Expert Search In A Modular Computing System”, and is a continuation-in-part of U.S. patent application Ser. No. 12/592,207 filed on Nov. 20, 2009, entitled “A Widgetized Avatar And A Method And System Of Creating And Using Same”, which is a continuation of U.S. patent application Ser. No. 12/381,663 filed on Mar. 13, 2009, entitled “A Widgetized Avatar And A Method And System Of Creating And Using Same”, which are herein incorporated by reference.

The present application is a continuation-in-part of U.S. patent application Ser. No. 12/709,839 filed on Feb. 22, 2010, entitled “System And Method For Defined Searching And Web Crawling”, which claims the benefit of U.S. Provisional Patent Application No. 61/208,277 filed on Feb. 20, 2009, entitled “System And Method For Defined Searching And Web Crawling”, which are herein incorporated by reference.

The present application is a continuation-in-part of U.S. patent application Ser. No. 12/711,666 filed on Feb. 24, 2010, entitled “Widget Platform, System and Method”, which is continuation-in-part of U.S. patent application Ser. No. 12/383,001 filed on Mar. 17, 2009, entitled “Widget Platform, System and Method”, which claims the benefit of U.S. Provisional Patent Application No. 61/069,777 filed on Mar. 17, 2008, entitled “Widget Platform, System and Method,”, which are herein incorporated by reference.

The present application is a continuation-in-part of U.S. patent application Ser. No. 12/719,218 filed on Mar. 8, 2010, entitled “Virtual Marketplace Accessible To Widgetized Avatars”, which is a continuation-in-part of U.S. patent application Ser. No. 12/628,046 filed on Nov. 30, 2009, entitled “A Virtual Marketplace Accessible To Widgetized Avatars”, which claims the benefit of U.S. Provisional Patent Application No. 61/207,980 filed on Feb. 17, 2009, entitled “System And Method For Providing Expert Search In A Modular Computing System”, and is a continuation-in-part of U.S. patent application Ser. No. 12/592,207 filed on Nov. 20, 2009, entitled “A Widgetized Avatar And A Method And System Of Creating And Using Same”, which is a continuation of U.S. patent application Ser. No. 12/381,663 filed on Mar. 13, 2009, entitled “A Widgetized Avatar And A Method And System Of Creating And Using Same”, which are herein incorporated by reference.

The present application is a continuation-in-part of U.S. patent application Ser. No. 12/722,058 filed on Mar. 11, 2010, entitled “System And Method For Providing User Access”, which claims the benefit of U.S. Provisional Patent Application No. 61/209,974 filed on Mar. 11, 2009, entitled “System And Method For Providing User Access”, which are herein incorporated by reference.

The present application is a continuation-in-part of U.S. patent application Ser. No. 12/730,500 filed on Mar. 24, 2010, entitled “Apparatus, System and Method for an Icon Drive Tile Bar in a Graphical User Interface”, which claims the benefit of U.S. Provisional Application No. 61/210,936 filed on Mar. 24, 2009, entitled “Apparatus, System and Method for an Icon Drive Tile Bar in a Graphical User Interface”, which are herein incorporated by reference.

The present application is a continuation-in-part of U.S. patent application Ser. No. 12/783,153 filed on May 19, 2010, entitled “Device and Method for Creating, Distributing, Managing and Monetizing Widgets in a Mobile Environment”, which claims the benefit of U.S. Provisional Patent Application No. 61/216,718 filed on May 20, 2009, entitled “A Device And Method For Creating, Distributing, Managing And Monetizing Widgets In A Mobile Environment”, and also claims priority to U.S. patent application Ser. No. 12/586,884 filed on Sep. 29, 2009, entitled “A Device and Method for Creating, Distributing, Managing and Monetizing Widgets”, and U.S. patent application Ser. No. 12/568,904 filed on Sep. 29, 2009, entitled “Device and Method for Creating, Distributing, Managing and Monetizing Widgets”, each of which claims the benefit of U.S. Provisional Patent Application No. 61/210,190 filed on Mar. 12, 2009, entitled “A Device and Method for Creating, Distributing, Managing and Monetizing Widgets”, and U.S. patent application Ser. No. 12/755,818 filed on Apr. 7, 2010, entitled “A Device and Method For Creating, Distributing, Management and Monetizing Widgets Using Templates”, which claims the benefit of U.S. Provisional Patent Application No. 61/212,129 filed on Apr. 7, 2009, entitled “A Device and Method for Creating, Distributing, Managing and Monetizing Widgets Using Templates”, which are herein incorporated by reference.

The present application is a continuation-in-part of U.S. patent application Ser. No. 12/783,172 filed on May 19, 2010, entitled “Device and Method for Creating, Distributing, Managing and Monetizing Widgets Including Streaming”, which claims the benefit of U.S. Provisional Patent Application No. 61/216,717 filed on May 20, 2009, entitled “Device and Method for Creating, Distributing, Managing and Monetizing Widgets Including Streaming”, which are herein incorporated by reference.

The present application is a continuation-in-part of U.S. patent application Ser. No. 12/848,276 filed on Aug. 2, 2010, entitled “Virtual Marketplace Accessible To Widgetized Avatars”, which is a continuation-in-part of U.S. patent application Ser. No. 12/719,218 filed on Mar. 8, 2010, entitled “A Virtual Marketplace Accessible To Widgetized Avatars”, which is a continuation-in-part of U.S. patent application Ser. No. 12/628,046 filed on Nov. 30, 2009, entitled “A Virtual Marketplace Accessible To Widgetized Avatars”, which are herein incorporated by reference.

The present application claims the benefit of U.S. Provisional Patent Application No. 61/707,845 filed on Sep. 28, 2012, entitled “Tablet Computer for Children”, which are herein incorporated by reference.

### FIELD

The present disclosure relates in general to the field of computing devices. In particular, the present disclosure relates to a time and sleep control system and method.

### BACKGROUND

A traditional computing device (e.g., a personal computer and a tablet computer) includes an operating system (OS) and one or more application programs. The OS typically boots up a user interface or a customized user interface that resides on top of the OS. A single user interface on a computing device may have the following problems:

Open/unrestricted access: All users (e.g., a parent and a child) have access to the same applications and content on the tablet computer;

Lack of privacy: Personal information regarding one user may be disclosed to another user;

Lack of security: One user may have unauthorized access to another user's information; and

Content Management: Content displayed on a user interface cannot be filtered or restricted based on a user profile.

To address these problems, a traditional method includes providing a dual OS computing environment. In a typical dual OS computing environment, a user has to either: (1) select a first OS to boot up and reboot to select a second OS; (2) simultaneously boot up two OSes and switch from one OS to another by performing a keystroke or an action; or (3) access one or more OSes on a virtual machine that resides on the Internet or a network.

The disadvantages of a dual OS computing environment include the time and inconvenience of rebooting to switch from one OS to another OS, an incompatibility of applications and/or content across different OSes running simultaneously, and a requirement of an Internet and/or a network to access an OS on a virtual machine.

### SUMMARY

A time and sleep control system and method is disclosed. According to one embodiment, a computer-implemented method includes providing a first user interface on a computing device that provides digital content to a first user, providing a second user interface associated with an operating environment on the computing device to a second user, where the second user interface provides unrestricted access to the digital content, receiving a request that is configured to be provided by the second user to access the first user interface from the operating environment, where the request allows the second user to provide restricted access to the digital content on the first user interface, granting the request, and receiving a desired time duration on the computing device that is configured to be provided by the second user, where the desired time duration controls a length of time that the first user is allowed to access the first user interface.

The above and other preferred features, including various novel details of implementation and combination of elements, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments.

### BRIEF DESCRIPTION OF THE FIGURES

The accompanying figures, which are included as part of the present specification, illustrate the various embodiments of the present disclosed system and method and together with the general description given above and the detailed description of the preferred embodiments given below serve to explain and the teach the principles of the present disclosure.

FIG. 1 illustrates a top view of an exemplary computer system, according to one embodiment.

FIG. 2 illustrates a side view of an exemplary computer system, according to one embodiment.

FIG. 3 illustrates a flow chart of an exemplary process for providing time control, according to one embodiment.

FIG. 4 illustrates a flowchart of an exemplary process for providing adaptive learning, according to one embodiment.

FIGS. 5-10 illustrate exemplary user interfaces of a tutorial guide for configuring time control, according to one embodiment.

FIGS. 11-28 illustrate exemplary supervisory user interfaces of the present computer system, according to one embodiment.

FIGS. 29-34 illustrate exemplary child-friendly user interfaces of the present computer system, according to one embodiment.

FIG. 35 illustrates an exemplary computer architecture that may be used for the present system, according to one embodiment.

It should be noted that the figures are not necessarily drawn to scale and elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims.

### DETAILED DESCRIPTION

A time and sleep control system and method is disclosed. According to one embodiment, a computer-implemented method includes providing a first user interface on a computing device that provides digital content to a first user, providing a second user interface associated with an operating environment on the computing device to a second user, where the second user interface provides unrestricted access to the digital content, receiving a request that is configured to be provided by the second user to access the first user interface from the operating environment, where the request allows the second user to provide restricted access to the digital content on the first user interface, granting the request, and receiving a desired time duration on the computing device that is configured to be provided by the second user, where the desired time duration controls a length of time that the first user is allowed to access the first user interface.

Each of the features and teachings disclosed herein can be utilized separately or in conjunction with other features and teachings to provide a time and sleep control system and method. Representative examples utilizing many of these additional features and teachings, both separately and in combination, are described in further detail with reference to the attached figures. This detailed description is merely intended to teach a person of skill in the art further details for practicing preferred aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

According to one embodiment, there is a need for a computing device that overcomes the problems associated with a single user interface while providing multiple users with customizable, manageable, user-appropriate user environments, and access to applications, content, and device settings. Additionally, there is a need for a computing user environment that is adapted for a desired user (e.g., a child) whereby a control of the desired user's time spent on a computing device can be monitored and regulated. There is further a need for a computing user environment that notifies the desired user and de-activates the computing device when the desired user's use time of the computing device has exceeded a pre-determined use time. There is also a need for a computing user environment that encourages a desired user behavior by providing an incentive to a user, who performs an activity of educational or other constructive benefit. These incentives include an access to an activity of interest to the user, such as an access to entertainment content (e.g., a game, music, and a video).

According to one embodiment, the present computer system includes a user environment and an access control for an OS and an application. The present computer system includes a processor, a display screen, a loudspeaker, a navigation control, and a wireless data communication interface. The present computer system further includes a non-transitory machine-readable storage medium that stores instructions, which when executed by the processor causes the processor to perform operations according to the instructions. The non-transitory machine readable storage medium includes an OS that has an application framework layer, an application layer, and instructions that enable a user to interact with the OS using the navigation control.

The present computer system further includes an OS overlay system that is configured to be executed by the processor. In one embodiment, the OS overlay system includes instructions for executing a hypervisor configured to provide an operating platform having a first operating environment associated with a first user interface, a second operating environment associated with a second user interface, and an application space providing access to the application layer. The overlay system is configured to be activated when the present computer system is turned on, and disabled when the present computer system is in a dormant state for a pre-determined period of time. The OS overlay system includes a time limitation mechanism, a system control mechanism, a monitoring control mechanism, an integrated adaptive learning system, one or more remotely accessible parental controls, a curated application store, multiple profile management capabilities, and child-safe browsing capabilities.

According to one embodiment, the system control mechanism allows the monitoring control mechanism to provide or restrict access to the computer system, to the first user interface or to an application. The monitoring control mechanism obtains an operating configuration from the time limitation mechanism, tracks the amount of time spent on an activity, and whether a condition has been met or not to authorize access to the present computer system (such as the completion of a skill acquisition exercise, as further described below). According to one embodiment, the OS overlay system includes a time limitation mechanism that provides instructions for controlling an access to an application program in the application layer. The time limitation mechanism includes an instruction for providing the first user interface, an instruction for providing the second operating environment associated with the second user interface, an instruction for requesting an authentication code to access the first user interface from the second operating environment, and an instruction for an access control that is configured to permit or deny a request for access to the first user interface in the second operating environment. The access control permits or denies a request for access to one or more of a system setting, an application program, a data, and a hardware resource on the first user interface. The data includes, but is not limited to, an Internet resource, a text file, an image file, an audio file, a video file, and an electronic book. According to one embodiment, the time limitation mechanism includes a time monitoring interface that tracks and reports the amount of active time that a user has spent accessing an application on the present computer system. The time monitoring interface further includes instructions that receive a desired utilization time to control the duration of user access to the present computer system. The time monitoring interface may be configured by a remote content source using the wireless data communication interface, according to one embodiment. Instructions for the time monitoring interface and management of website content may be monitored from a remote computing device and/or the present computer system.

According to one embodiment, the OS overlay system includes an access control that includes instructions for controlling an activation and/or a de-activation of the present computer system, measuring a time spent on the present computer system and activities performed by a user with the present computer system (e.g., accessing an electronic book application, a music application, a game, a movie, and an educational application). The access control includes an instruction for receiving a user input including a request for accessing the first user interface in the second operating environment, an instruction for determining whether a request for accessing the first user interface in the second operating environment is permitted under a setting of the access control, and an instruction for approving or denying the request for accessing the first user interface in the second operating environment. The setting of the access control includes a configuration in the second user interface for determining whether an application can be accessed by a user in the first user interface, and a time limit for accessing an application in the first user interface. According to one embodiment, the access control includes an instruction for requesting a confirmation of compliance with one or more conditions specified in the first user interface before permitting access to the first user interface in the second operating environment. The conditions provide requirements for the authentication code, WiFi access, and a set of security rules to be met. The authentication code may be provided as a user input or via an external authentication mechanism for approving a request to access the first user interface in the second operating environment. In another embodiment, the overlay system includes an instruction for tracking a user's activity (e.g., accessing an electronic book application, a music application, a game, a movie, and an educational application) on the first user interface in the second operating environment, an instruction for generating a report regarding the user's activity in the first user interface in the second operating environment, and an instruction for displaying the report in the second user interface. In another embodiment, the overlay system includes instructions for accepting an access control configuration from a different computer using the wireless data communication interface, and an instruction for communicating the report to a different computer using the wireless data communication interface.

According to one embodiment, the OS overlay system includes an adaptive learning system that provides instructions for executing a direct instructional component such as a skill definition exercise or a skill acquisition exercise. The skill definition exercise provides an assessment of a user's level of proficiency in a particular skill. The skill acquisition exercise provides instructional items as well as a measurement of the skill acquisition against a standard that can be set by the supervising user (e.g. a passing grade). The direct instructional component organizes, provides and monitors the skill acquisition exercise to ensure the acquisition or reinforcement of the skill.

The skill acquisition exercise includes a courseware definition and personalization mechanism for presenting instructional material to a user. The courseware definition includes a plurality of skill definition exercises that measure the user's level of proficiency before generating personalized skill acquisition exercises (e.g., a video lesson, a flashcard, and a practice lesson). The direct instructional component further includes an insight and recommendation dashboard for evaluating and tracking an assessment of the skill acquisition exercise. According to one embodiment, the performance of a child user after completing the skill acquisition exercise (e.g., a number of problems solved) is compared against a threshold level provided by a pre-defined performance indicator or a desired performance indicator configured by a supervisory user. The performance indicator includes, but is not limited to, a courseware level (e.g., a skillset, a topic, a lesson, and a problem), a reference period (e.g., a day, a week, and a month), and a proficiency level. The insight and recommendation dashboard provides a searchable repository of a child user's past achievements, an award, a certificate, and a reward. The insight and recommendation dashboard further provides a correlation between the performance of the child user to a time spent by the child user on the skill acquisition exercise, in one embodiment.

According to one embodiment, the insight and recommendation dashboard provides a recommendation for a subsequent stage in an advancement path. If the performance of the child user does not satisfy the threshold level, the adaptive learning system recommends additional skill acquisition exercises to the child user. For example, the additional skill acquisition exercises provide a lower level of difficulty than previous skill acquisition exercises. If the performance of the child user satisfies the threshold level, the adaptive learning system recommends additional skill acquisition exercises to the child user. For example, the additional skill acquisition exercises provide a higher level of difficult than previous skill acquisition exercises.

The adaptive learning system further includes a configuration and evaluation interface that provides instructions for executing an indirect instructional component to support the direct instructional component. The indirect instructional component includes a reinforcement that indirectly contributes to the acquisition of the skill definition exercise by having an effect on user motivation and behavior, for example, providing a practice frequency and a practice quantity of a skill acquisition exercise, providing a repetition of practice, ambition to improve proficiency, providing a competition between users and/or between a user and the present computer system to improve proficiency, providing a symbolical reward for an achievement (progress and proficiency), and providing a tangible or a virtual reward for an achievement.

The adaptive learning system further includes instructions for executing a technological enabler to support at least one of the direct instructional component and the indirect instructional component. A technological enabler operates the instructional components in a way that maximizes their utility value to the child user and to the supervising user. A technological enabler includes offline capabilities such as providing an operation of the adaptive learning system when the present computer system is not connected to a network so that a child user may continue to access a skill acquisition exercise, online capabilities to synchronize the child user's usage of the skill acquisition exercise when the present computer system is connected to a network (e.g., a cloud), data capture and acquisition based on the child user's usage of the skill acquisition exercise, a supervising user environment, and a privacy compliance system. The adaptive learning system provides data capture and acquisition in both offline and online modes, and synchronizes the present computer system with cloud services when the present computer system transitions from an offline mode to an online mode. This allows the user to continue assessing the skill acquisition exercise when an Internet connection is not available, while obtaining the same benefits as having an available Internet connection. The adaptive learning system further includes instructions for allowing a first user with authentication rights to control a utilization time duration of the present computer system by a second user.

According to one embodiment, the adaptive learning system includes an instruction that is associated with a configuration of the access control for allowing a supervisory user with authentication rights to control a time usage of the present computer system by a child user. The supervisory user may configure a desired time limit for a child user to access an application on the present computer system, and may further configure a first time period that the child user has to access a first application before providing the child user with a second time period to access a second application.

According to one embodiment, the access control allows the present computer system to hibernate at a pre-determined time even if the tablet computer is still in use at the pre-determined time. In another embodiment, the present computer system may convert to a locked state or a de-activated state, until the second user solves a pre-defined problem provided by the adaptive learning system. In another embodiment, the adaptive learning system includes at least one technological enabler that provides an instruction for receiving input data from an input source that includes, but is not limited to, a touch screen, a keyboard, a touch-sensitive pad, a mouse, a track ball, a pen device, a joystick, a game controller, a motion detecting device, a microphone, and a camera. The adaptive learning system may further include an instruction for capturing an offline use data that reflects access of the present computer system in an offline mode, and an instruction for using the wireless data communication interface to automatically transmit the offline use data to a different computer when the present computer system is in an online mode.

According to one embodiment, the present OS further includes at least two user interfaces that are each customized based on a specific type or profile of the user. Each user interface provides a different visual appearance and work flow. The present OS may include mobile OSes, such as ANDROID®, IOS®, BADA®, BLACKBERRY® OS, S40®, and WINDOWS PHONE®. The present OS may further include desktop or laptop OSes, such as WINDOWS® and MAC OS®. In one embodiment, the present OS includes a child-friendly user interface and a supervisory user interface for a family group of users having a parent and a child.

The child-friendly user interface allows access to applications, Web content, and games that are previously identified as appropriate for a target age or gender group (e.g., curated content). The present computer system allows the user to earn virtual currency by performing an activity, where the user may spend the virtual currency in an application store suitable for the target age or gender group. The present computer system may further provide core-curriculum, or state-standardized lessons for the user to improve his/her educational skills.

The supervisory user interface provides a default OS environment that allows unrestricted access to all applications and content, provides access to one or more settings of the present computer system, and allows access to control other user interfaces (e.g., the child-friendly user interface). The supervisory user interface also allows unrestricted access to content acquisition facilities such as an online application store, music store or video store, and allows purchases with one-click. The supervisory user interface allows a user to make an online purchase using pre-defined information (e.g., an address and credit card information) instead of manually inputting billing and shipping information to make a purchase. The supervisory user interface provides monitoring time and usage of content in the other user interfaces (e.g., the child-friendly user interface) and allows a user to view reports and analytics. The supervisory user interface allows a user to provide one or more restrictions to specific content on other user interfaces by one or more toggle switches or other similar controls. According to one embodiment, the toggle switches are implemented in an online dashboard that accessible by Internet and/or a network. It is understood that these exemplary user interfaces are solely for illustrative purposes, and shall not limit the scope of the present disclosure. The OS may be used in any multi-user environment that benefits from user profile-based customization of user interfaces and access to applications and content, without deviating from the scope of the present disclosure.

According to one embodiment, the present computer system receives a desired first time period and a desired second time period via the supervisory user interface. The desired first time period provides a duration that a child user has to access a first application (e.g., an educational application) on the child-friendly user interface before the present computer system provides the desired second time period for the child user to access a second application on the child-friendly user interface. The desired first time period and the desired second time period may be provided via the supervisory user interface using a user input to the present computer system or from pre-defined time periods.

According to one embodiment, the present computer system receives a desired completion of a skill acquisition exercise and a desired time period via the supervisory user interface. The present computer system receives an indication of the desired completion of the skill acquisition exercise before providing the desired time period to allow access to the child-friendly user interface.

According to one embodiment, the present computer system receives a desired first time period and/or a desired completion of a chore list before providing a desired second time period to access the child-friendly user interface. A chore may include a specified task that needs to be performed and a corresponding specified goal that includes a quantity or a frequency to be satisfied. For example, a specified task is brushing teeth, and a corresponding specified goal is a daily frequency. In one embodiment, the present computer system provides a chore list that includes pre-defined chores or tasks for configuration. In another embodiment, the chore list may be received by the present computer system as a user input to the supervisory user interface.

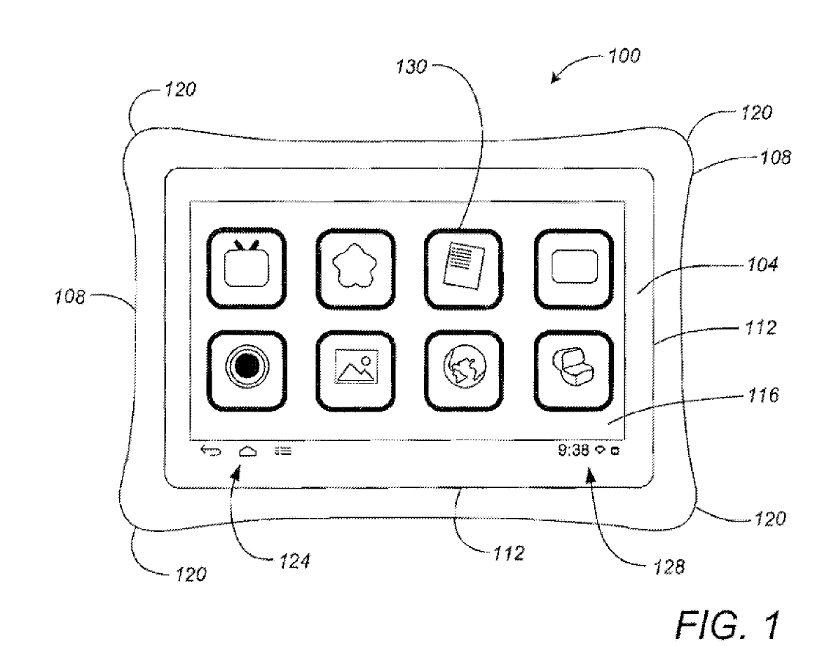

FIG. 1 illustrates a top view of an exemplary computer system, according to one embodiment. A computer system 100 includes a tablet computer 104 that is retained within an impact resistant protector 108. The protector 108 is made of a flexible material that may be placed around the tablet computer 104 by a user so that the tablet computer 104 is protected from damage due to a dropping impact. The protector 108 includes an opening 112 that enables the user to view and interact with a touch screen 116 of the tablet computer 104. The protector 108 includes corner regions 120 that prevent the tablet computer 104 from lying flat on a horizontal surface, such as a tabletop or a desk, to facilitate air-cooling of the tablet computer 104. The corner regions 120 further provide additional protection to the corners of the tablet computer 104 that tend to be particularly susceptible to damage when the tablet computer 104 is dropped.

The touch screen 116, one or more navigation controls 124, and one or more status indicators 128. The touch screen 116 allows the user to view and interact with information displayed on the touch screen 116. According to one embodiment, the touch screen 116 may be of the capacitive variety that allows the user to operate the tablet computer 104 by touching the touch screen 116 with a finger. In another embodiment, the touch screen 116 allows the user to operate the tablet computer 104 by touching the touch screen 116 with a stylus or other similar implement. It is understood that the tablet computer 104 includes internal hardware, as well as suitable firmware, that supports the functionality of the touch screen 116. In one embodiment, the tablet computer 104 includes an NVIDIA® TEGRA® processor having a quad-core with a fifth battery-saver core. It is understood that other processors may be implemented for the tablet computer 104 without deviating from the scope of the present disclosure.

The navigation controls 124 allow the user to operate the tablet computer 104, in addition to software controls that may be displayed on the touch screen 116. Typical navigation controls 124 that are familiar to the user include, but are not limited to, a back button, a home button, and a shortcut menu button. Typical status indicators 128 include, but are not limited to, a clock, a Wi-Fi signal strength indicator, and a recycle bin or trash can icon. It will be appreciated that a wide variety of symbols and functions may be used for, or associated with, the navigation controls 124 and the status indicators 128 without deviating from the scope of the present disclosure.

The tablet computer 104 further includes an OS overlay system 130 that interacts with software applications stored on the tablet computer 104. The OS overlay system includes a time limitation mechanism, a system control mechanism, a monitoring control mechanism, an integrated adaptive learning system, one or more granular, customizable, and remotely accessible parental controls, a curated application store, multiple profile management capabilities, and child-safe browsing capabilities.

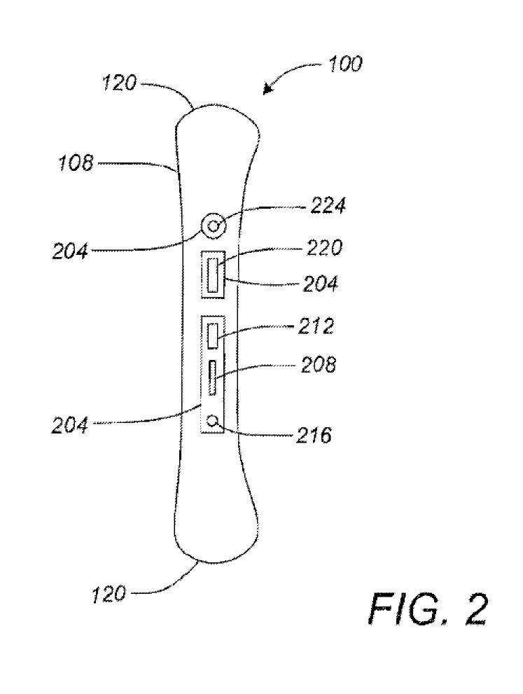

FIG. 2 illustrates a side view of an exemplary computer system, according to one embodiment. The protector 108 includes one or more openings 204 that provide an access to ports or slots on the exterior side of the tablet computer 104. Each opening 204 may be shaped and sized to match a corresponding pod or slot on the tablet computer 104. A marking may be applied on the protector 108 within the proximity of each opening 204 to indicate a function of each port or slot within the opening 204. It is understood that the openings 204 allow an insertion of memory chips, a plug to a peripheral device, a tip of a stylus, and other similar devices into the tablet computer 104, without deviating from the scope of the present disclosure.

As illustrated in FIG. 2, the tablet computer 104 includes a card slot 208 that is configured to receive a storage card. In one embodiment, the card slot 208 may be configured to receive removable memory, such as a Micro Secure Digital (SD) storage card. According to one embodiment, the card slot 208 and the internal firmware of the tablet computer 104 are configured to receive a Micro SD card having a storage capacity ranging up to substantially 32 Gigabytes (GB), or greater. It is understood that the card slot 208 and the internal firmware may be configured to operate with other types of storage cards having other storage capacities without deviating from the scope of the present disclosure.

The tablet computer 104 further includes a Micro Universal Serial Bus (USB) port 212 that is configured to connect the tablet computer 104 to an external computer by a USB cable. According to one embodiment, the Micro USB port 212 allows the user to install software applications from the tablet computer 104 onto the external computer, or vice versa. In another embodiment, the Micro USB port 212 allows the user to transfer data files (e.g., an image file, an audio file, and a video file) from the tablet computer 104 to the external computer, or vice versa. Moreover, the Micro USB port 212 allows the tablet computer 104 to be powered by the external computer using the USB cable. It will be recognized that the Micro USB port 212 may be used to charge an internal battery of the tablet computer 104 by the external computer using the USB cable or a power adapter that receives electrical power form a power outlet.

The tablet computer 104 further comprises a power adapter port 216 that is configured to connect to a power adapter cord to receive electrical power from a power outlet. According to one embodiment, the power adapter port 216 is configured to receive direct current (DC) at 5.0 Volts (V) from the power adapter. In another embodiment, the power adapter is configured to receive alternating current (AC) at between substantially 100V and 240V from the power outlet.

The tablet computer 104 further includes a Mini High-Definition Multimedia Interface (HDMI) port 220. It will be appreciated by those skilled in the art that the Mini HDMI port 220 connects the tablet computer 104 an external digital video device, including, but not limited to, a digital camera, a camcorder, and other digital devices having Mini HDMI connectors. It is understood that the tablet computer 104 includes internal firmware that supports connecting to the external digital video device, as well as processing data files (e.g., an image, an audio file, and a video file). The data files may be formatted into popular file formats, including, but not limited to, JPEG format for an image file, MPEG-1 or MPEG-2 Audio Layer III (MP3) or Advanced Audio Coding (AAC) formats for an audio file, and MPEG-4 Part 14 (MP4) for a video file. In another embodiment, the internal firmware may support a video compression standard, including, but not limited to, H.263 and H.264 video compression standards. Those skilled in the art will recognize that a wide variety of image, audio, and video standards may be implemented without deviating from the scope of the present disclosure.

The tablet computer 104 further includes a headphone jack 224 that is configured to connect to an external headphone speaker. When an external headphone speaker is plugged into the headphone jack 224, audible sounds that are otherwise played using the loudspeakers within the tablet computer 104 are played using the external headphone speaker. According to one embodiment, the loudspeakers within the tablet computer 104 are disabled when the external headphone speaker is plugged into the headphone jack 224. The headphone jack 224 is a 3.5 mm standard audio jack, according to one embodiment. The headphone jack 224 may be configured for use with external loudspeakers that are larger and/or more powerful than the loudspeakers within the tablet computer 104, according to another embodiment. A wide variety of uses, configurations, and alternative forms of the headphone jack 224 will be apparent to those skilled in the art without deviating from the present disclosure.

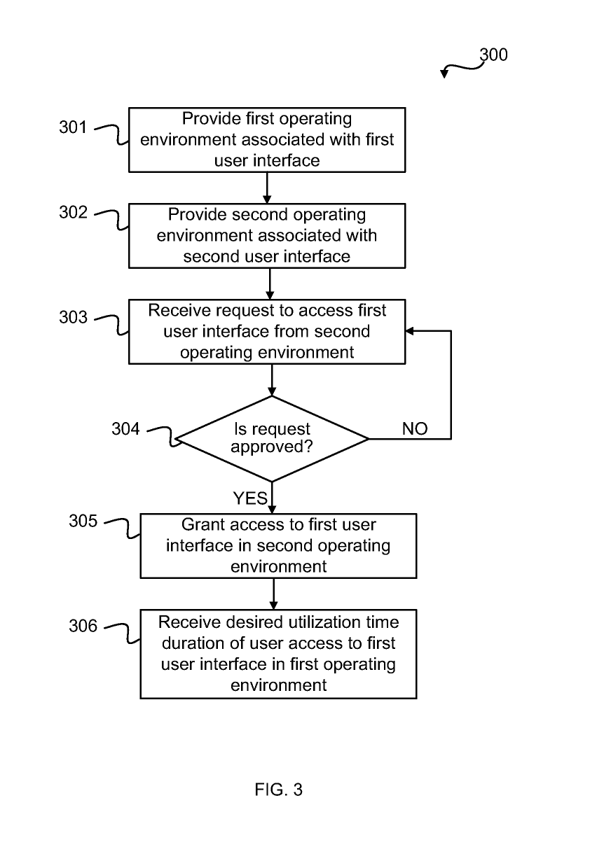

FIG. 3 illustrates a flow chart of an exemplary process for providing time control, according to one embodiment. The OS overlay system provides a first operating environment associated with a first user interface (at 301). According to one embodiment, the first user interface is provided to a first type of user (e.g., a child). The OS overlay system provides a second operating environment associated with a second user interface (at 302). According to one embodiment, the second user interface is provided to a second type of user (e.g., a parent). The OS overlay system receives a request to access the first user interface from the second operating environment (at 303). In one embodiment, the OS overlay system receives a request that includes an authentication code using an authentication system.

The OS overlay system determines if the request is approved (at 304) based on an operative configuration and/or a compliance with a condition specified in the first user interface. If the request is not approved, the OS overlay system waits to receive another request to access the first user interface from the second operating environment (at 303). If the request is approved, the OS overlay system grants access to the first user interface in the second operating environment (at 305). The OS overlay system further receives a desired utilization time duration of user access from the second type of user to the first user interface in the first operating environment (at 306).

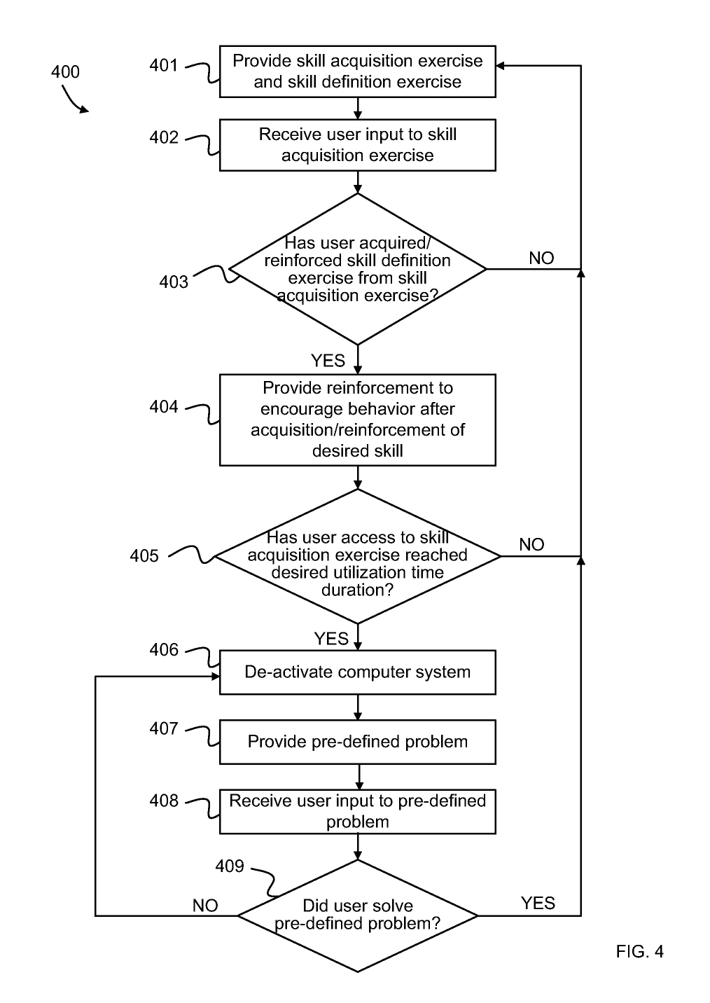

FIG. 4 illustrates a flowchart of an exemplary process for providing adaptive learning, according to one embodiment. The OS overlay system provides a skill acquisition exercise and a skill definition exercise (at 401). The OS overlay system receives a user input to the skill acquisition exercise (at 402). The OS overlay system determines whether the user has acquired and/or reinforced the skill from the skill acquisition exercise (at 403). If the user has not acquired and/or reinforced the desired skill, the OS overlay system returns to provide the skill acquisition exercise (at 401). If the user has acquired and/or reinforced the desired skill, the OS overlay system provides a reinforcement to encourage the user's behavior after the acquisition and/or reinforcement of the desired skill (at 404). The OS overlay system determines if user access to the skill acquisition exercise has reached a desired utilization time duration (at 405). If user access to the skill acquisition exercise has not reached the desired utilization time duration, the OS overlay system continues to provide the skill acquisition exercise (at 401). If user access to the skill acquisition exercise has reached the desired utilization time duration, the OS overlay system de-activates the computer system (at 406).

It is appreciated that the OS overlay system can de-activate the computer system at any stage of the process if user access has reached the desired utilization time duration. The OS overlay system provides a pre-defined problem (at 407). The OS overlay system receives a user input to the pre-defined problem (at 408). The OS overlay system determines if the user has solved the pre-defined problem (at 409). If the user has not solved the pre-defined problem, the OS overlay system continues to de-activate the computer system (at 407). If the user has solved the pre-defined problem, the OS overlay system returns to provide the skill acquisition exercise (at 401).

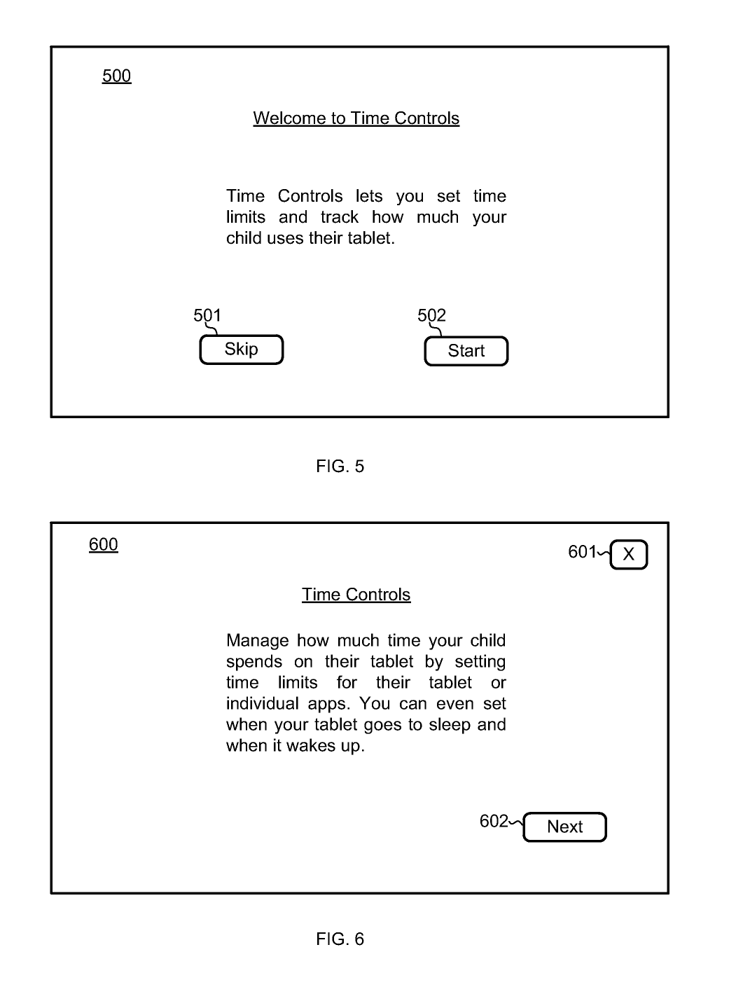

FIGS. 5-10 illustrate exemplary user interfaces of a tutorial guide for configuring time control, according to one embodiment. Referring to FIG. 5, the user interface 500 provides information describing that a supervisory user (e.g., a parent) may configure a desired time limit for a child user to access the present computer system, and track the child user's time usage of the present computer system. The user interface 500 further includes a skip button 501 and a start button 502 to allow the supervisory user to discontinue or continue browsing the tutorial guide respectively.

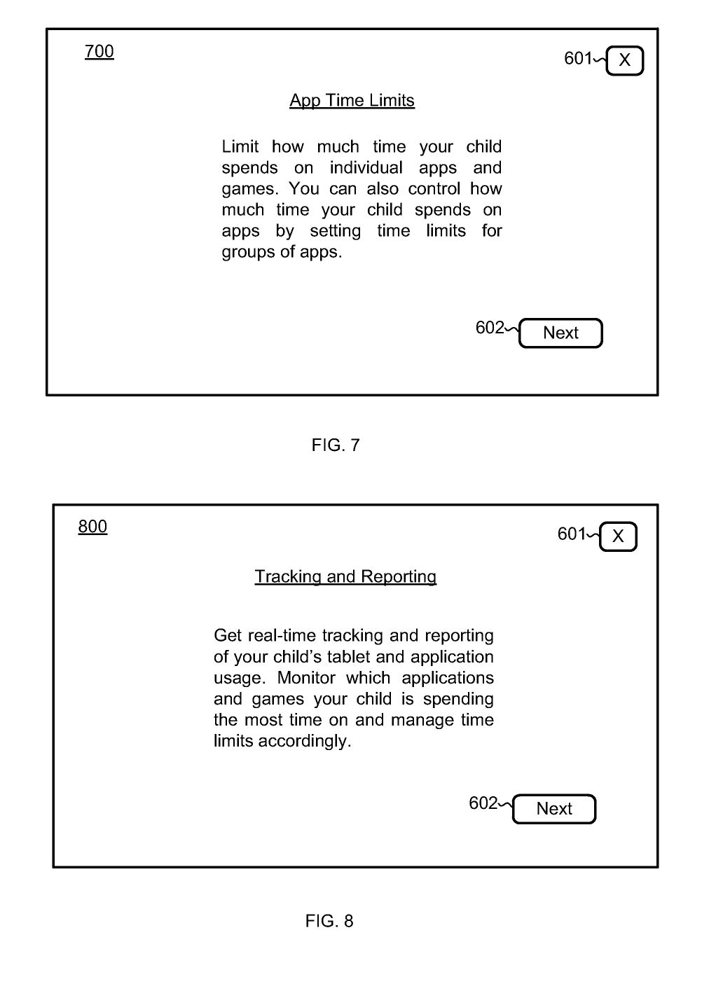

Referring to FIG. 6, the user interface 600 provides information describing that the supervisory user may configure a desired time limit for the child user to access the present computer system or an application on the present computer system, as well as configure a desired time range to activate and de-activate the present computer system. The user interface 600 further includes a close button 601 and a next button 602 to allow the supervisory user to discontinue or continue browsing the tutorial guide respectively. The user interface 700 of FIG. 7 provides information describing that the supervisory user may configure a desired time limit for the child user to access one or more applications and/or games.

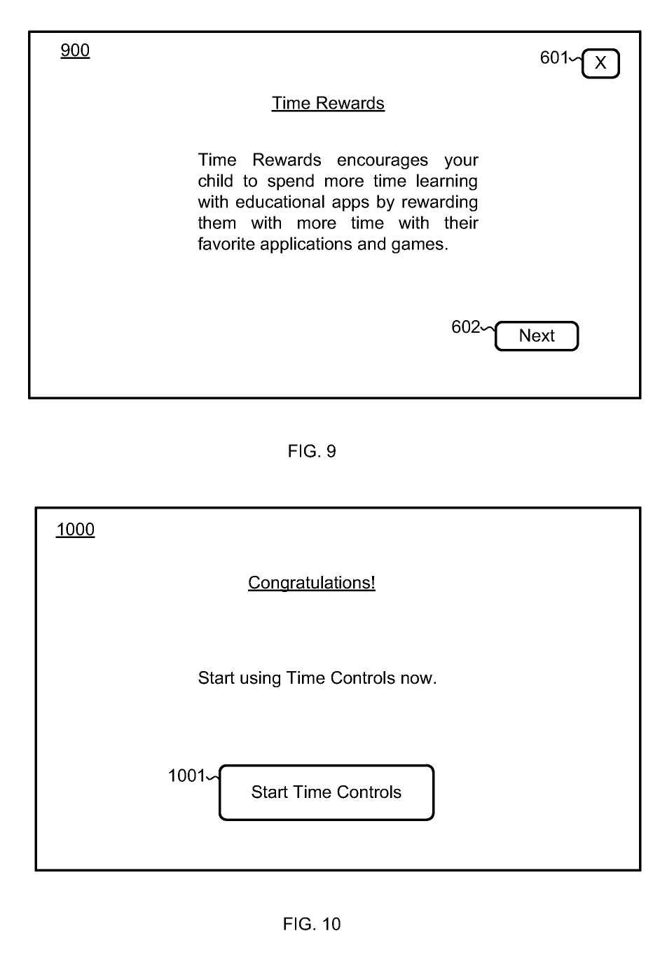

The user interface 800 of FIG. 8 provides information describing that the supervisory user may receive a real-time usage tracking report of the child user's time usage of the present computer system and an application on the present computer system. The usage tracking report allows the supervisory user to monitor which applications and/or games are most frequently used by the child user so that the supervisory user may configure a desired time limit. The user interface 900 of FIG. 9 provides information describing that the supervisory user may configure a first time period that the child user has to access a first application (e.g., an educational application) before providing the child user with a second time period to access a second application and/or a game. The second time period is referred to as a time reward. The user interface 1000 of FIG. 10 provides information describing that the supervisory may provide a configuration of time control by selecting a start button 1001.

FIGS. 11-28 illustrate exemplary supervisory user interfaces of the present computer system, according to one embodiment. Referring to FIG. 11, the supervisory user interface 1100 includes a description of a child user 1106 (e.g., a name) including an image 1101 of the child user 1106 and the child user 1106's time usage 1102 (e.g., 2 hours) for accessing the present computer system. The supervisory user interface 1100 further provides selection buttons 1103, 1104, and 1105 for configuring a time limit for the child user 1106 to access the present computer system and/or an application on the present computer system, viewing usage details for the child user 1106, and configuring a time reward respectively.

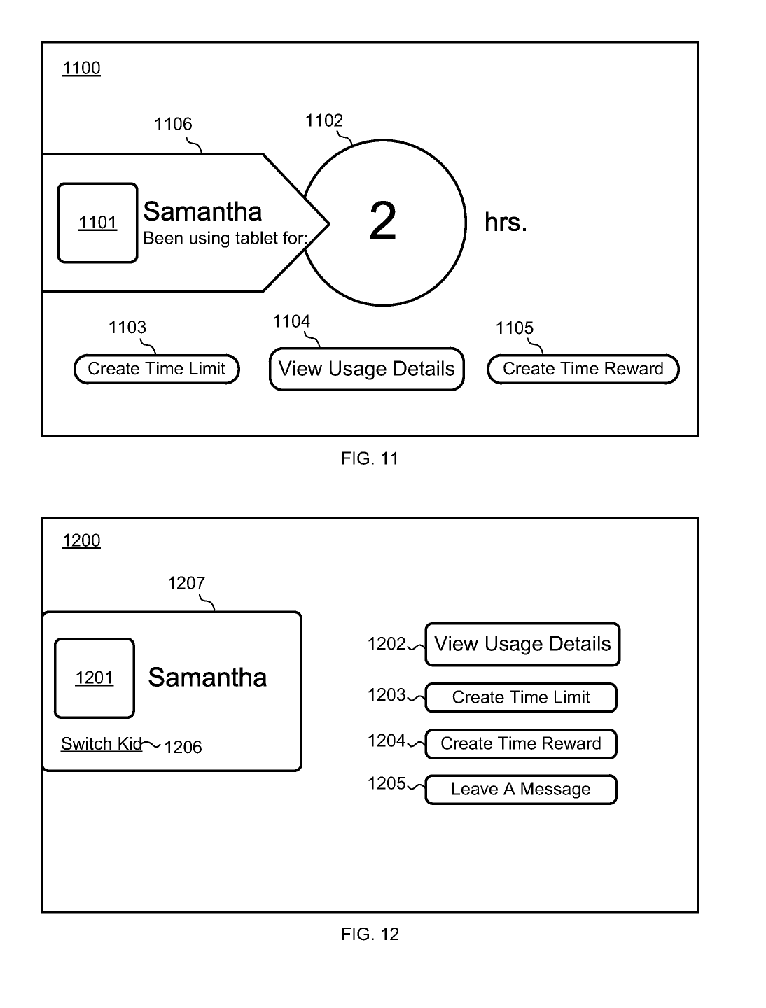

Referring to FIG. 12, the supervisory user interface 1200 includes a description of a child user 1207 (e.g., a name) including an image 1201 of the child user 1207, and provides a selection 1206 of another child user. The supervisory user interface 1200 further provides selection buttons 1202, 1203, 1204, and 1205 for viewing usage details of the child user 1207, configuring a time limit for the child user 1207 to access the present computer system and/or an application on the present computer system, configuring a time reward, and leaving a message for the user 1207 respectively.

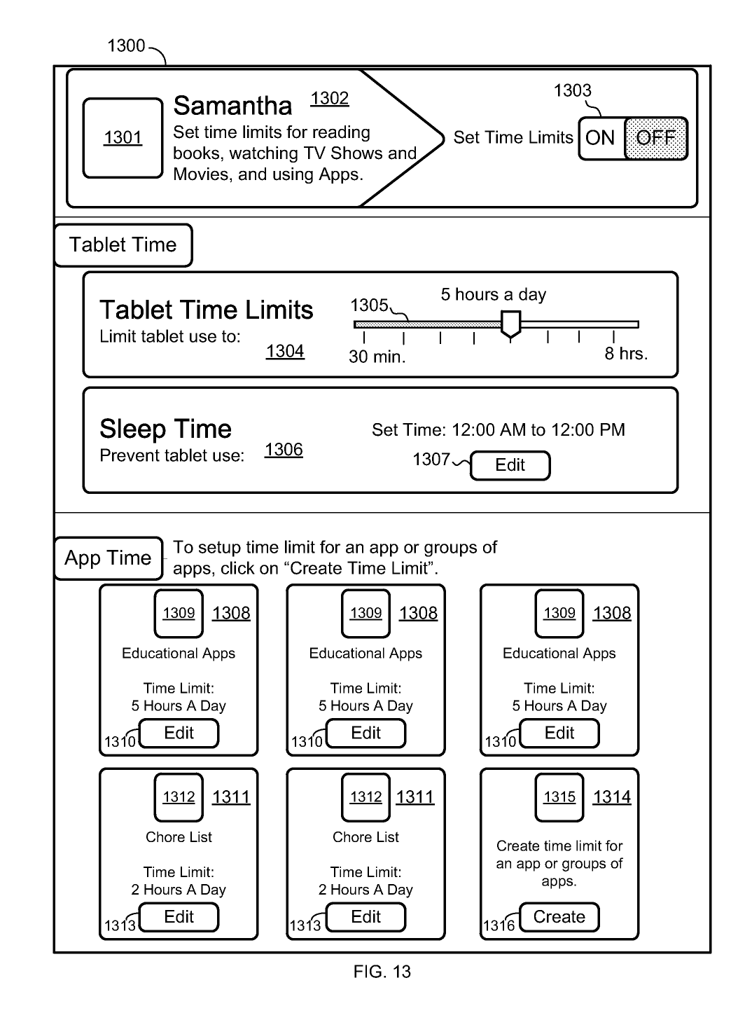

Referring to FIG. 13, the supervisory user interface 1300 includes a description of a user 1302 (e.g., a name) including an image 1301 of the user 1302, and an on/off button 1303 to enable or disable a time limit for the user 1302 to access the present computer system and/or an application on the present computer system. The supervisory user interface 1300 provides a time limit display 1304 including a time limit configuration 1305 for configuring a desired time limit for a child user 1302 to access the present computer system. In one embodiment, the time limit configuration 1305 is provided using a slider control. It is understood that the time limit configuration 1305 may be provided using various forms without deviating from the scope of the present disclosure.

The supervisory user interface 1300 provides a sleep time display 1306 that displays a time range that the present computer system is de-activated. The supervisory user interface 1300 includes a sleep time configuration button 1307 for configuring a desired time range to de-activate the present computer system. The supervisory user interface 1300 further provides an application time limit display 1314 including an image 1315 and a create button 1316 for configuring a desired time limit for one or more applications. The user interface 1300 may include one or more existing application time limit displays 1308 that each displays an existing time limit for one or more applications, including an image 1309, and an edit button 1310 for configuring the existing time limit. The user interface 1300 may include one or more chore list displays 1311 that each displays an existing time limit for a chore list, including an image 1312, and a configuration button 1313 for configuring a desired time limit for performing one or more chores.

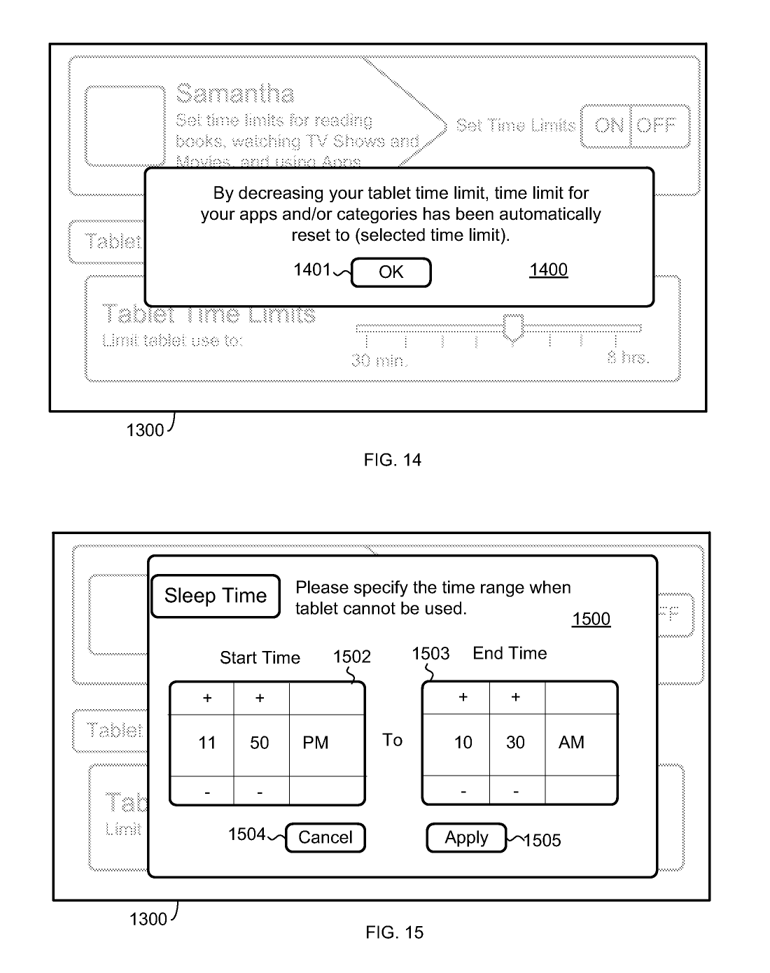

According to one embodiment, if a user configures the time limit configuration 1305 by moving the slider control to the left, this indicates a reduction in a time limit. The present computer system receives this indication and provides a supervisory user interface 1400 as in FIG. 14 that provides information describing that a time limit for an application and/or a category of applications has been reset to the reduced time limit, and a confirmation button 1401 for indicating an acceptance of the information. In one embodiment, the supervisory user interface 1400 is superimposed over the supervisory user interface 1300.

According to one embodiment, if a user selects the sleep time configuration button 1307, the present computer system provides a supervisory user interface 1500 as in FIG. 15 that provides settings that are configured by a start time configuration 1502 and an end time configuration 1503. The supervisory user interface 1500 further provides a cancel button 1504 to cancel a configuration of the sleep time configuration and an apply button 1505 to store the configured settings. In one embodiment, the supervisory user interface 1500 is superimposed over the supervisory user interface 1300.

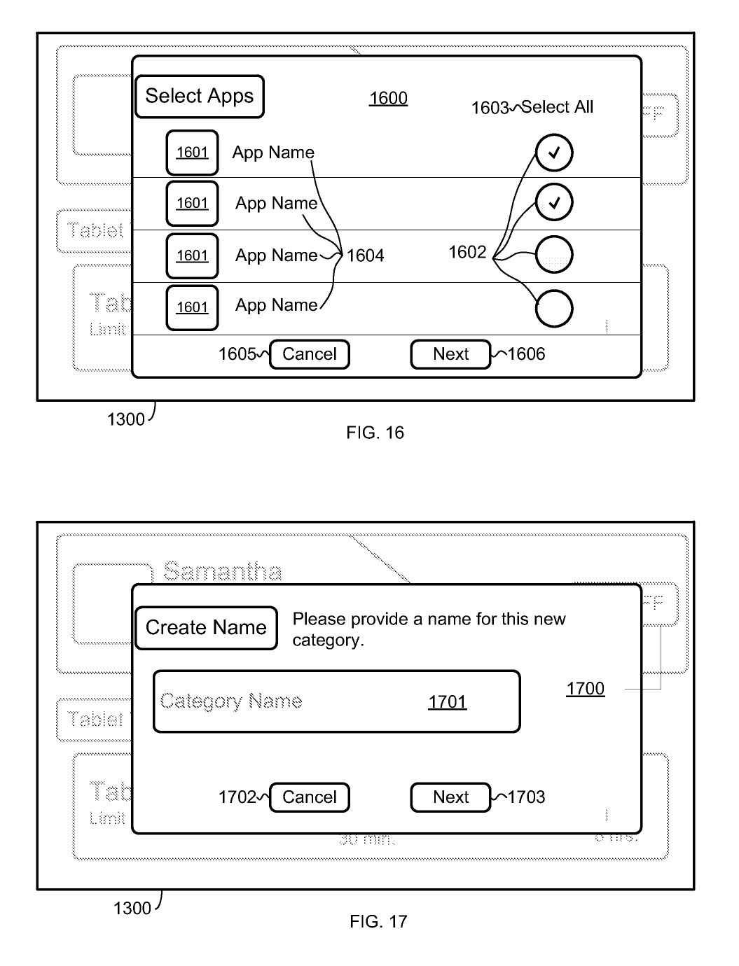

According to one embodiment, if a user selects the create button 1316, the present computer system provides a supervisory user interface 1600 as in FIG. 16 that provides a plurality of applications 1604 and corresponding images 1601. The supervisory user interface 1600 provides a selection button 1602 for selecting a corresponding application 1604 and a select all button 1603 for selecting the plurality of applications 1604. The supervisory user interface 1600 further provides a cancel button 1605 to cancel the selection of applications and a next button 1606 to store a desired selection of the applications 1604 and provide further configuration. In one embodiment, the supervisory user interface 1600 is superimposed over the supervisory user interface 1300.

Referring to FIG. 17, the supervisory user interface 1700 provides a configuration of a category name 1701 for a plurality of selected applications, a cancel button 1702 to cancel a configuration of the category name 1701 and a next button 1703 to store the configuration of the category name 1701 and provide further configuration. In one embodiment, the supervisory user interface 1700 is superimposed over the supervisory user interface 1300.

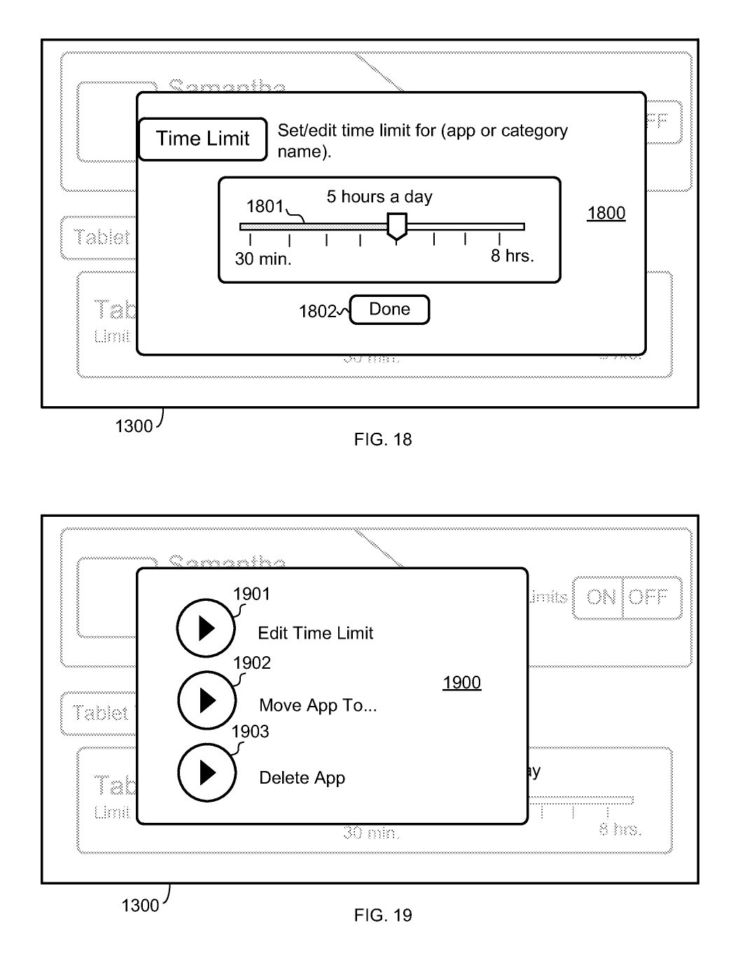

Referring to FIG. 18, the supervisory user interface 1800 provides a time limit configuration 1801 for configuring a desired time limit for a child user 1302 to access an application or a category of applications on the present computer system. The supervisory user interface 1800 provides a done button 1802 to store the configured time limit. In one embodiment, the supervisory user interface 1800 is superimposed over the supervisory user interface 1300.

Referring to FIG. 19, the supervisory user interface 1900 provides configuration buttons 1901, 1902, and 1903 for editing a time limit for accessing one or more applications, moving an application from one category to another category, and deleting an application from a category respectively. In one embodiment, the supervisory user interface 1900 is superimposed over the supervisory user interface 1300.

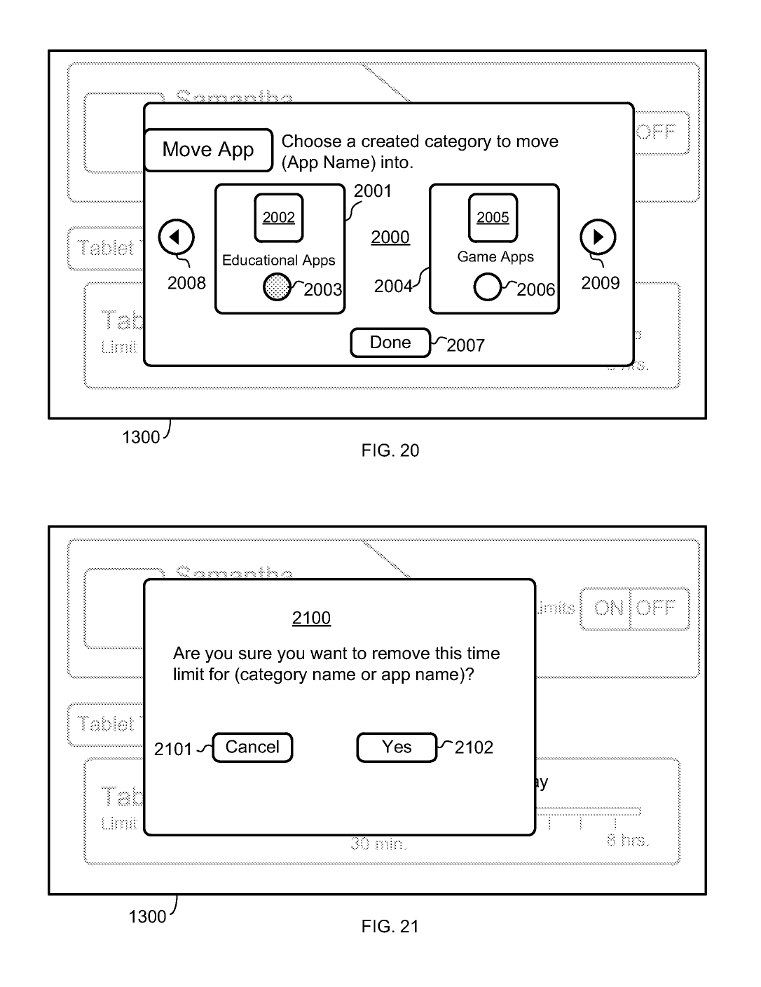

If the user selects a configuration button 1902 for moving an application from one category to another category, the present computer system provides a supervisory user interface 2000 as in FIG. 20 that provides an educational application category 2001 and a game application category 2005 that each includes corresponding images 2002, 2005 and corresponding buttons 2003 and 2006 for selecting a category to move an application into. It is understood that the supervisory user interface 2000 can provide other types of categories without deviating from the scope of the present disclosure. In FIG. 20, the user may select the button 2003 to indicate a movement of an application into the educational application category 2001. The supervisory user interface 2000 provides a done button 2007 to store a configuration of the category for moving an application into. The supervisory user interface 2000 further includes scrolling buttons 2008 and 2009 for selecting other categories. In one embodiment, the supervisory user interface 2000 is superimposed over the supervisory user interface 1300.

Referring to FIG. 21, the supervisory user interface 2100 provides a configuration of removing a time limit for a category or an application. The supervisory user interface 2100 includes a cancel button 2101 to cancel a configuration of removing the time limit, and a yes button 2102 to confirm a removal of the time limit for a category or an application. In one embodiment, the supervisory user interface 2100 is superimposed over the supervisory user interface 1300.

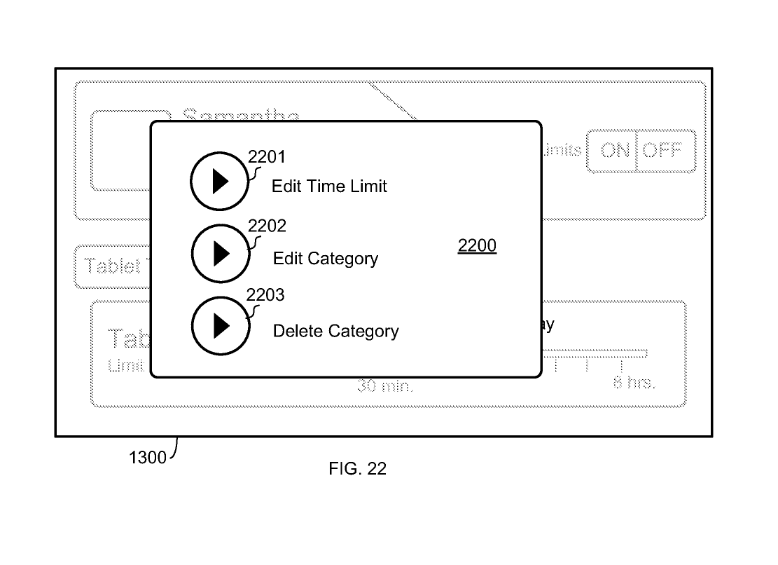

Referring to FIG. 22, the supervisory user interface 2200 provides configuration buttons 2201, 2202, and 2203 for editing a time limit for accessing a category, editing a category, and deleting a category respectively. In one embodiment, the supervisory user interface 2200 is superimposed over the supervisory user interface 1300.

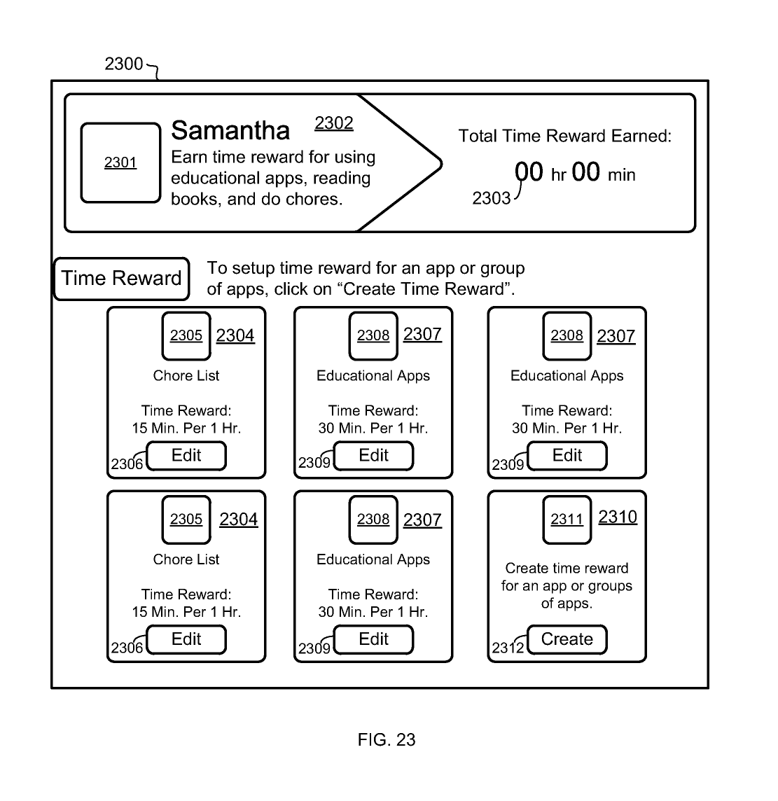

Referring to FIG. 23, the supervisory user interface 2300 includes a description of a child user 2302 (e.g., a name) including an image 2301 of the child user 2302 and his/her total time reward earned 2303. The supervisory user interface 2300 provides a time reward display 2310 including a time reward image 2311 and a create button 2312 for configuring a time reward for one or more applications. The supervisory user interface 2300 may include one or more application displays 2307 that each displays an existing time reward for accessing one or more applications, including an image 2308, and an edit button 2309 for editing an existing time reward for accessing one or more applications. The supervisory user interface 2300 may include one or more chore list displays 2304 that each displays an existing time reward for completing a chore list, including an image 2305, and an edit button 2306 for editing an existing time reward for completing the chore list. In one embodiment, the present computer system provides a chore list that includes pre-defined chores or tasks for configuration. In another embodiment, the chore list may be received by the present computer system as a user input to the supervisory user interface.

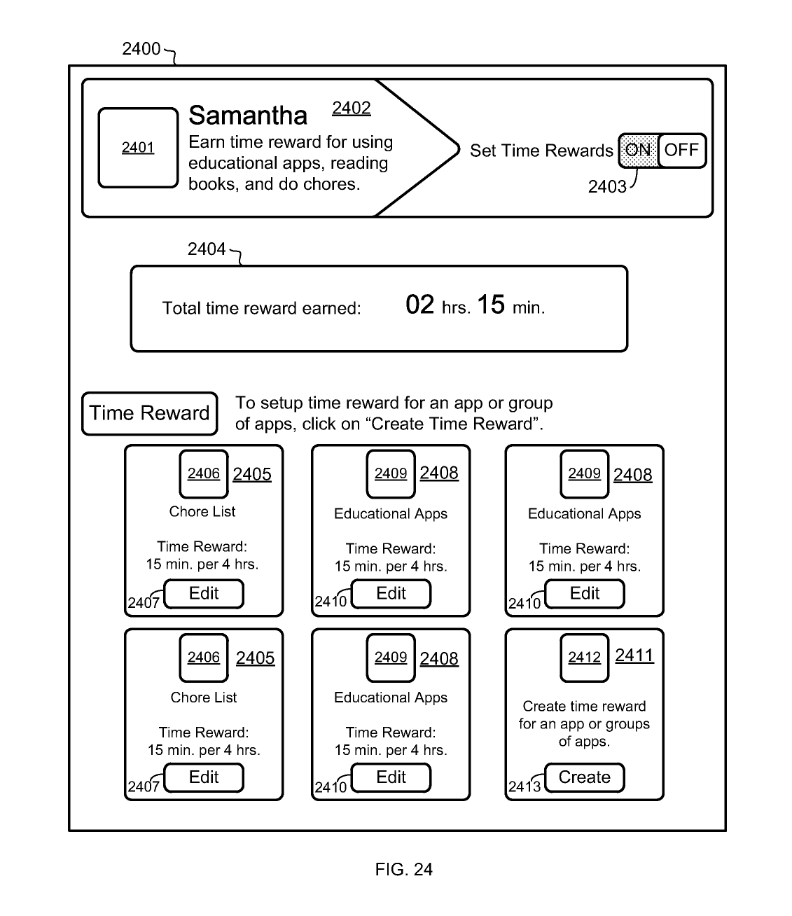

Referring to FIG. 24, the supervisory user interface 2400 includes a description of a child user 2402 (e.g., a name) including an image 2401 of the child user 2402, a control button 2403 for enabling or disabling a configuration of time rewards, and the child user 2402's total reward earned 2404. The supervisory user interface 2400 provides a time reward display 2411 including an image 2412 and a create button 2413 for configuring a time reward for one or more applications. The user interface 2400 may include one or more application displays 2408 that each displays an existing time reward for accessing one or more applications, including an image 2409, and an edit button 2410 for editing an existing time reward for accessing one or more applications. The user interface 2400 may include one or more chore list displays 2405 that each displays an existing time reward for completing a chore list, including an image 2406, and an edit button 2407 for editing an existing time reward for completing the chore list.

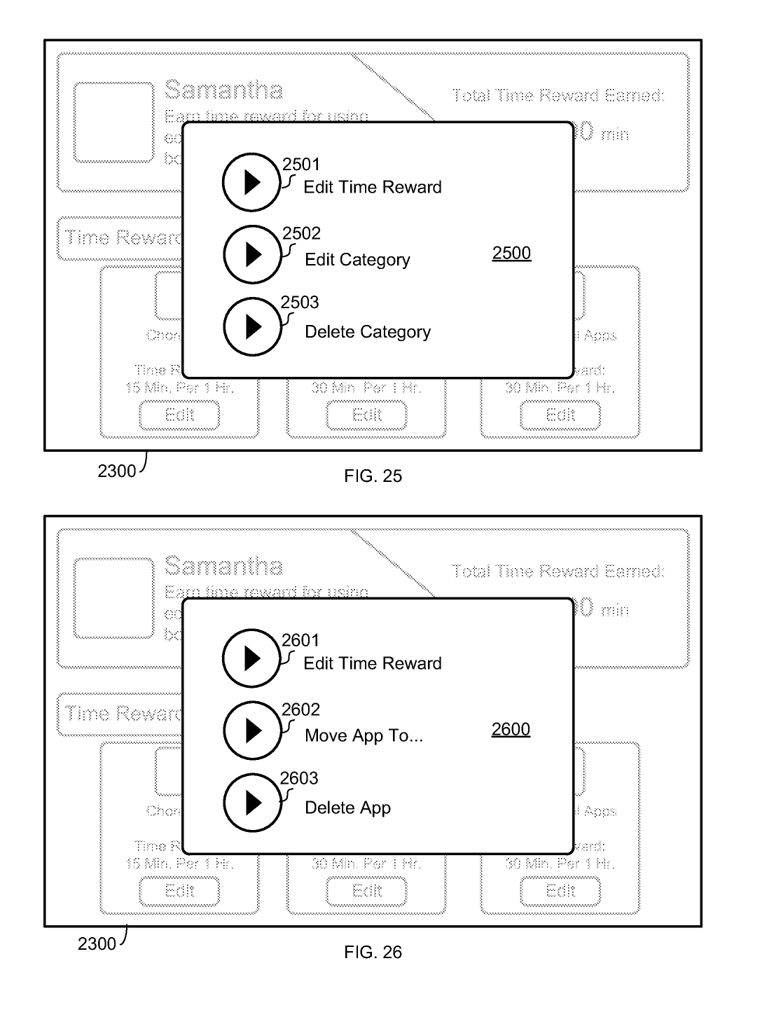

Referring to FIG. 25, the supervisory user interface 2500 provides configuration buttons 2501, 2502, and 2503 for editing a time reward, editing a category, and deleting a category respectively. In one embodiment, the supervisory user interface 2500 is superimposed over the supervisory user interface 2300.

Referring to FIG. 26, the supervisory user interface 2600 provides configuration buttons 2601, 2602, and 2603 for editing a time reward, moving an application from one category to another category, and deleting an application from a category respectively. In one embodiment, the supervisory user interface 2600 is superimposed over the supervisory user interface 2300.

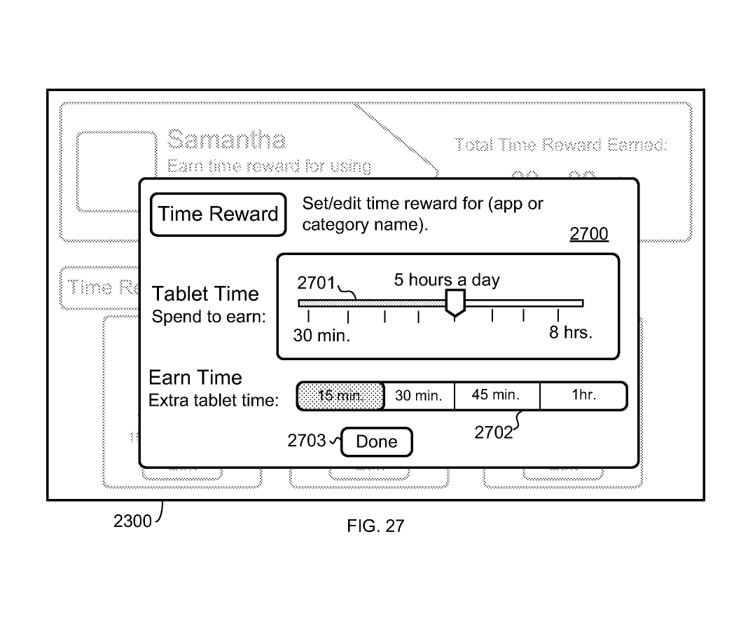

Referring to FIG. 27, the supervisory user interface 2700 provides a time effort configuration 2701 for a child user to access an application or complete a chore before being rewarded with a time reward defined using a time reward configuration 2702. The supervisory user interface 2700 provides a done button 2703 to store a desired time effort configuration 2701 and a desired time reward configuration 2702. In one embodiment, the supervisory user interface 2700 is superimposed over the supervisory user interface 2300.

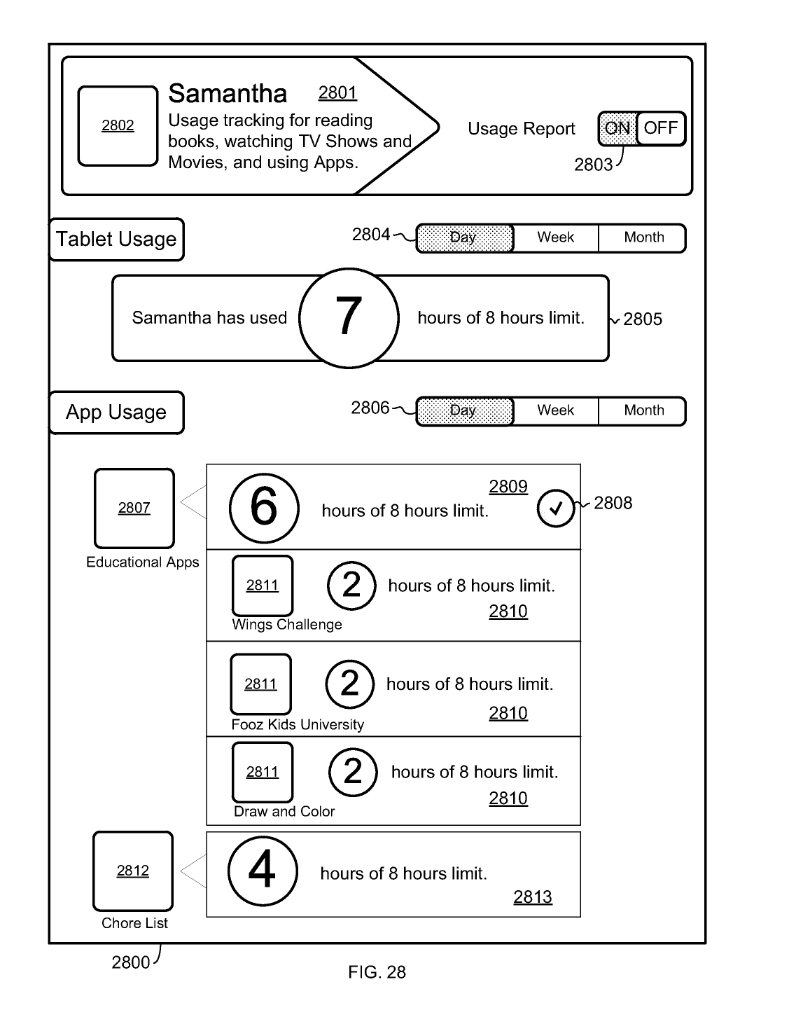

Referring to FIG. 28, the supervisory user interface 2800 provides a usage tracking report for a child user 2801 including an image 2802 of the child user 2801 and a configuration button 2803 for enabling or disabling the usage tracking report. The supervisory user interface 2800 provides the child user 2801's total time usage 2805 for accessing the present computer system, where the total time usage 2805 may be configured 2804 by a day, a week, or a month. The supervisory user interface 2800 further provides a category time usage 2809 that displays the child user 2801's time usage for accessing one or more applications in a category, including a category image 2807. The category time usage 2809 may further provide in detail a plurality of application time usages 2810 each including an application image 2811. The supervisory user interface 2800 provides a chore list time usage 2813 that displays the child user 2801's time usage on chores, including a chore image 2812.

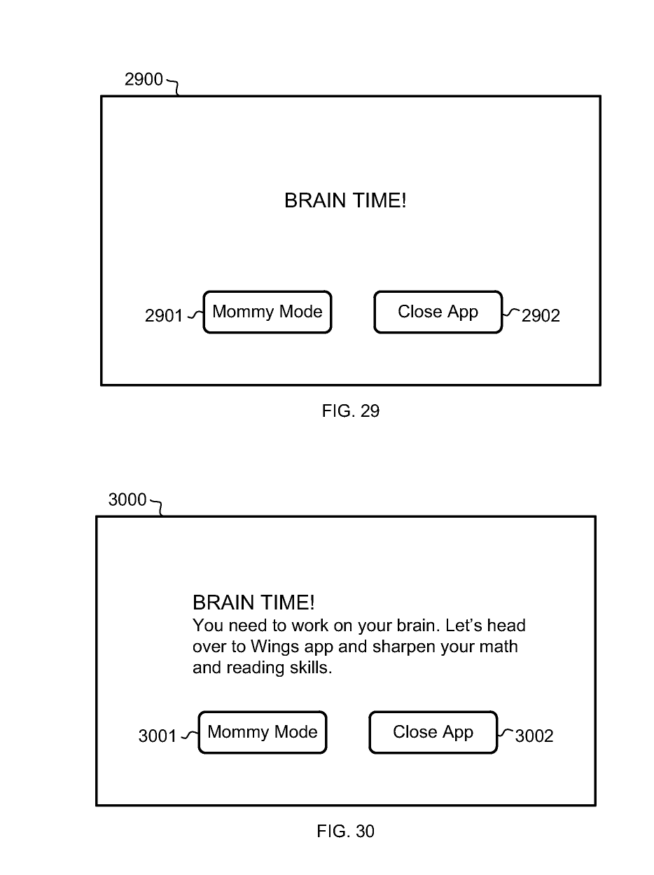

FIGS. 29-34 illustrate exemplary child-friendly user interfaces of the present computer system, according to one embodiment. Referring to FIGS. 29 and 30, the child-friendly user interface 2900 and 3000 provides an expiration of a desired time limit for accessing an application. The child-friendly user interface 2900 and 3000 each provides a supervisory user button 2901 and 3001 to allow a supervisory user to access a supervisory user interface, and a close application button 2902 and 3002 for closing an application.

According to one embodiment, the present computer system provides a character video via the child-friendly user interface to inform the child user of the expiration of the desired time limit. The character video may feature a virtual character that provides an interaction with the child user to provide various instructions or directions (e.g., to stop accessing an application, to study, and to sleep). This enhances a user experience of the present computer system, and allows the child user to believe that the present computer system is the one that provides a time limit, and not the supervisory user.

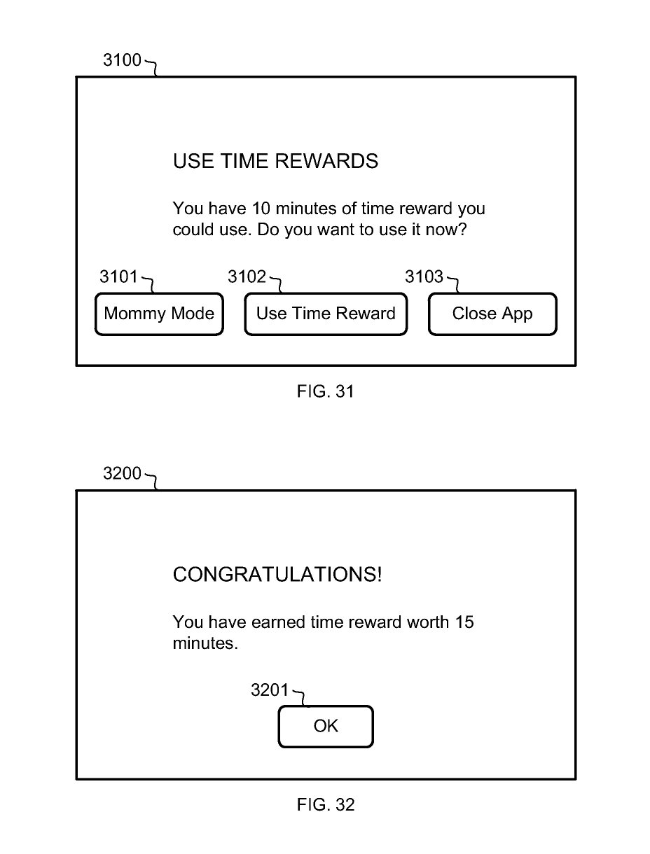

Referring to FIG. 31, the child-friendly user interface 3100 provides a description that a child user has earned a particular time reward (e.g., 10 minutes). The child-user interface 3100 provides a use time reward button 3102 to prompt the child user to use his/her time rewards, a close application button 3103, and a supervisory user button 3101 to allow a supervisory user to access a supervisory user interface. Referring to FIG. 32, the child-friendly user interface 3200 provides a description that a child user has earned a particular time reward (e.g., 15 minutes). The child-user interface 3200 provides a confirmation button 3201 for indicating an acceptance of the information.

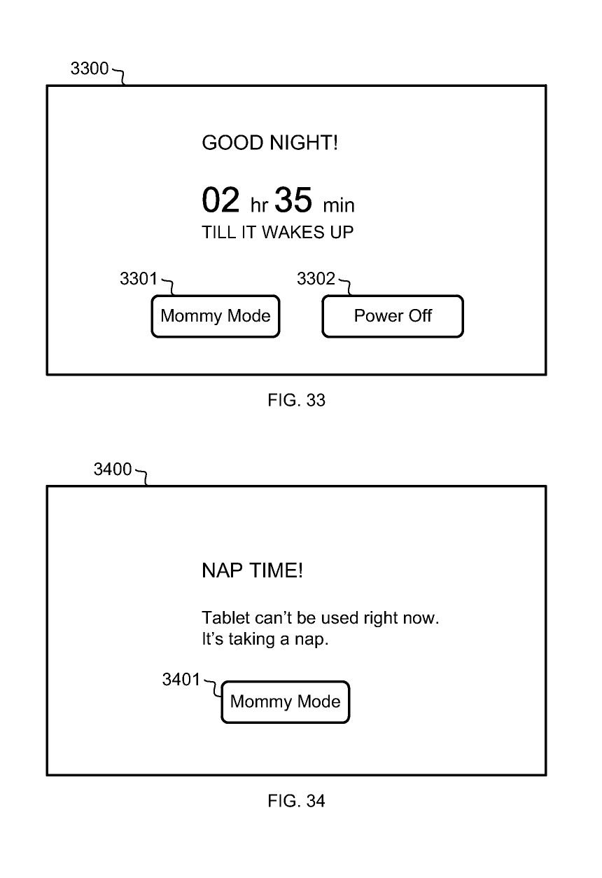

Referring to FIG. 33, the child-friendly user interface 3300 provides an expiration of a desired time limit for accessing an application. The child-friendly user interface 3300 provides a supervisory user button 3301 to allow a supervisory user to access a supervisory user interface, and a power off button 3302 to shut down the present computer system. Referring to FIG. 34, the child-friendly user interface 3400 provides an expiration of a desired time limit for accessing an application. The child-friendly user interface 3400 provides a supervisory user button 3401 to allow a supervisory user to access a supervisory user interface.

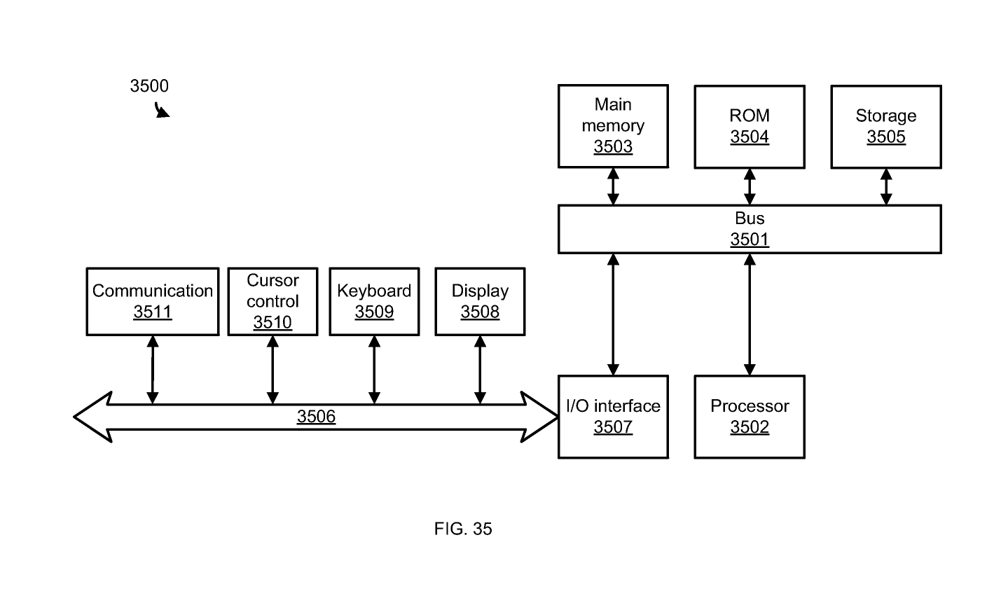

FIG. 35 illustrates an exemplary computer architecture that may be used for the present system, according to one embodiment. The exemplary computer architecture may be used for implementing one or more components described in the present disclosure including, but not limited to, the present system. One embodiment of architecture 3500 includes a system bus 3501 for communicating information, and a processor 3502 coupled to bus 3501 for processing information. Architecture 3500 further includes a random access memory (RAM) or other dynamic storage device 3503 (referred to herein as main memory), coupled to bus 3501 for storing information and instructions to be executed by processor 3502. Main memory 3503 also may be used for storing temporary variables or other intermediate information during execution of instructions by processor 3502. Architecture 3500 may also include a read only memory (ROM) and/or other static storage device 3504 coupled to bus 3501 for storing static information and instructions used by processor 3502.

A data storage device 3505 such as a magnetic disk or optical disc and its corresponding drive may also be coupled to architecture 3500 for storing information and instructions. Architecture 3500 can also be coupled to a second I/O bus 3506 via an I/O interface 3507. A plurality of I/O devices may be coupled to I/O bus 3506, including a display device 3508, an input device (e.g., an alphanumeric input device 3509 and/or a cursor control device 3510).

The communication device 3511 allows for access to other computers (e.g., servers or clients) via a network. The communication device 3511 may include one or more modems, network interface cards, wireless network interfaces or other interface devices, such as those used for coupling to Ethernet, token ring, or other types of networks.

The above example embodiments have been described hereinabove to illustrate various embodiments of implementing a time and sleep control system and method. Various modifications and departures from the disclosed example embodiments will occur to those having ordinary skill in the art. The subject matter that is intended to be within the scope of the disclosure is set forth in the following claims.

We claim:

1. A computer-implemented method, comprising:
providing a first user interface on a computing device to a first user, wherein the computing device provides digital content;
providing a second user interface associated with an operating environment on the computing device to a second user, wherein the second user interface provides unrestricted access to the digital content;
receiving a request that is configured to be provided by the second user to access the first user interface from the operating environment, wherein the request allows the second user to provide restricted access to the digital content on the first user interface;
granting the request; and
receiving a desired time duration on the computing device that is configured to be provided by the second user, wherein the desired time duration controls a length of time that the first user is allowed to access the first user interface.

2. The computer-implemented method of claim 1, wherein the request comprises an authentication code.

3. The computer-implemented method of claim 1, wherein granting the request is based on a setting that includes a configuration in the second user interface to determine whether an application is configured to be accessed by the first user in the first user interface, and the desired time duration.

4. The computer-implemented method of claim 1, wherein granting the request to the second user is based on compliance with a specified condition in the first user interface, wherein the specified condition includes one or more requirements for an authentication code, a WiFi access, and a set of security rules.

5. The computer-implemented method of claim 1, wherein granting the request to the second user further comprises allowing the first user to access one or more of a system setting, an application, a data, and a hardware resource in the first user interface from the operating environment.

6. The computer-implemented method of claim 1, wherein the data comprises one or more of an Internet resource, a text, an image file, an audio file, a video file, and an electronic book.

7. The computer-implemented method of claim 1, further comprising receiving the desired time duration from a remote content source using a wireless data communication interface.

8. The computer-implemented method of claim 1, further comprising:
tracking an activity in the operating environment;
generating a report including the activity; and
displaying the report.

9. The computer-implemented method of claim 1, further comprising providing one or more of a skill acquisition exercise and a skill definition exercise.

10. The computer-implemented method of claim 1, further comprising de-activating the first user interface based on an expiration of the desired time duration.

11. The computer-implemented method of claim 10, further comprising providing a problem to the first user.

12. The computer-implemented method of claim 11, further comprising activating the first user interface to the first user based on receiving a solution to the problem.

13. The computer-implemented method of claim 1, further comprising:
receiving a desired first time period to access a first application on the first user interface and a desired second time period to allow access to a second application on the first user interface; and
receiving an indication of expiration of the desired first time period prior to providing the desired second time period.

14. The computer-implemented method of claim 9, further comprising:
receiving a desired completion of the skill acquisition exercise and a desired time period to allow access to the first user interface; and
receiving an indication of the desired completion of the skill acquisition exercise prior to providing the desired time period.

15. The computer-implemented method of claim 1, further comprising:
receiving a desired completion of a specified chore and a desired time period to allow access to the first user interface, wherein the chore includes a specified task to be performed and a corresponding specified goal that includes one of a quantity and a frequency to be satisfied; and
receiving an indication of the desired completion of the specified chore prior to providing the desired time period.

16. The computer-implemented method of claim 1, further comprising providing a character video on the first user interface, wherein the character video provides a direction after an expiration of the desired time duration.

17. A non-transitory computer readable medium having stored thereon computer-readable instructions, and a processor coupled to the non-transitory computer readable medium, wherein the processor executes the instructions to:
provide a first user interface on a computing device to a first user, wherein the computing device provides digital content;
provide a second user interface associated with an operating environment on the computing device to a second user, wherein the second user interface provides unrestricted access to the digital content;
receive a request that is configured to be provided by the second user to access the first user interface from the operating environment, wherein the request allows the second user to provide restricted access to the digital content on the first user interface;
grant the request; and
receive a desired time duration that is configured to be provided by the second user, wherein the desired time duration controls a length of time that the first user is allowed to access the first user interface.

18. The non-transitory computer readable medium of claim 17, wherein the request comprises an authentication code.

19. The non-transitory computer readable medium of claim 17, wherein the processor executes the instructions to grant the request based on a setting that includes a configuration in the second user interface to determine whether an application is configured to be accessed by the first user in the first user interface, and the desired time duration.

20. The non-transitory computer readable medium of claim 17, wherein the processor executes the instructions to grant the request to the second user based on compliance with a specified condition in the first user interface, wherein the specified condition includes one or more requirements for an authentication code, a WiFi access, and a set of security rules.

21. The non-transitory computer readable medium of claim 17, wherein the processor executes the instructions to grant the request to the second user further comprising the processor executes the instructions to allow the first user to access one or more of a system setting, an application, a data, and a hardware resource in the first user interface from the operating environment.

22. The non-transitory computer readable medium of claim 17, wherein the data comprises one or more of an Internet resource, a text, an image file, an audio file, a video file, and an electronic book.

23. The non-transitory computer readable medium of claim 17, wherein the processor executes the instructions to receive the desired time duration from a remote content source using a wireless data communication interface.

24. The non-transitory computer readable medium of claim 17, wherein the processor executes the instructions to:
track an activity in the operating environment;
generate a report including the activity; and
display the report.

25. The non-transitory computer readable medium of claim 17, wherein the processor executes the instructions to provide one or more of a skill acquisition exercise and a skill definition exercise.

26. The non-transitory computer readable medium of claim 17, wherein the processor executes the instructions to de-activate the first user interface based on an expiration of the desired time duration.

27. The non-transitory computer readable medium of claim 26, wherein the processor executes the instructions to provide a problem to the first user.

28. The non-transitory computer readable medium of claim 27, wherein the processor executes the instructions to activate the first user interface to the first user based on receiving a solution to the problem.

29. The non-transitory computer readable medium of claim 17, wherein the processor executes the instructions to:
receive a desired first time period to access a first application on the first user interface and a desired second time period to allow access to a second application on the first user interface; and
receive an indication of expiration of the desired first time period prior to providing the desired second time period.

30. The non-transitory computer readable medium of claim 25, wherein the processor executes the instructions to:
receive a desired completion of the skill acquisition exercise and a desired time period to allow access to the first user interface; and
receive an indication of the desired completion of the skill acquisition exercise prior to providing the desired time period.

31. The non-transitory computer readable medium of claim 17, wherein the processor executes the instructions to:
receive a desired completion of a specified chore and a desired time period to allow access to the first user interface, wherein the chore includes a specified task to be performed and a corresponding specified goal that includes one of a quantity and a frequency to be satisfied; and
receive an indication of the desired completion of the specified chore prior to providing the desired time period.

32. The non-transitory computer readable medium of claim 17, wherein the processor executes the instructions to provide a character video on the first user interface, wherein the character video provides a direction after an expiration of the desired time duration.
